(19) United States
(12) Patent Application Publication
(10) Pub. No.: US 2006/0063575 A1
(43) Pub. Date: Mar. 23, 2006

(54) Dynamic theming of a gaming system

(75) Inventors: Jean-Marie Gatto, London (GB); Thierry Brunet De Courssou, Henderson, NV (US)

Correspondence Address: YOUNG LAW FIRM;A PROFESSIONAL CORPORATION, 4370 ALPINE ROAD SUITE 106, PORTOLA VALLEY, CA, 94028, US

(73) Assignee: Cyberscan Technology, Inc., Palo Alto, CA (US)

(21) Appl. No.: 11/245,955

(22) Filed: Oct. 6, 2005

Related U.S. Application Data
(63) Continuation-in-part of application No. 10/789,975, filed on Feb. 27, 2004.
(60) Provisional application No. 60/453,627, filed on Mar. 10, 2003.

(51) Int. Cl. A63F 13/00

(52) U.S. Cl. 463/1

(57) ABSTRACT

A method and system for dynamically configuring all or part of a casino floor to a theme targeted at a predetermined population of patrons. The configuration of the gaming machines may be controlled from a central system in accordance with a predetermined theme or alternatively the patrons may activate their favorite theme interactively at the gaming machine. The predetermined theme may be selected according to patron characteristics including, for example, nationality, ethnic origin, gender, racial identity, geographic origin, favorite hobby, political association, sexual orientation, preferred sport, musical idol or genre, age and/or faith of the patrons of the plurality of gaming machines. A hierarchical menu of authorized games may be dynamically generated from the patron characteristics and presented to the patron according to the patron's characteristics and associated theme is determined such that the patron is likely to quickly find his favorite game. The gaming system may include video cameras and microphones, at locations monitoring a group of gaming machines or fitted on each gaming machines, and recognition software for recognizing patrons' characteristics such as age group, clothing style, hair color, isolated person or a party of persons, language spoken, and ethnic origin in order to dynamically adapt the gaming machines' theme accordingly. Alternatively, contact-less player tracking cards supply characteristics as the patrons move around the casino premises.

### CROSS-REFERENCE TO RELATED CASES

This application is a continuation-in-part of commonly assigned and co-pending application Ser. No. 10/789,975, filed Feb. 27, 2004, which application claims the benefit of provisional application Ser. No. 60/453,627, filed Mar. 10, 2003, both applications of which are hereby incorporated herein by reference in their entirety, and from which applications priority is hereby claimed under 35 U.S.C. §119(e) and §120.

### BACKGROUND OF THE INVENTION

1. Field of the Invention

The present inventions relate generally to the field of network connected pay computer-controlled games, either games of skills or games of chance, and more particularly to the field of automated monitoring and control of a large number of clusters of pay gaming terminals. The gaming terminals may be slot machines, video lotteries, bingo systems or lottery terminals in all their forms; that is, desktop terminals, wall or pedestal mounted kiosks, or full size consoles, operating either in a local area network (LAN) or in a wide area network (WAN). The present inventions also relate to the monitoring, control and payment systems linked to the gaming terminals.

2. Description of the Prior Art and Related Information

Pay entertainment and gaming systems of the prior art, either of the cash-in or the cash-less type, are seriously limited due to the technical choices made in order to comply with gaming regulatory requirements. Regulators are mainly concerned with funds that may be illegally acquired by individuals as well as with funds that may not be acquired by legitimate winners as a result of flaws, cheating and/or stealing. Game regulators are reluctant to accept state-of-the-art operating systems, multimedia and Internet technologies because of security concerns and tend to favor antiquated technology based upon secrecy rather that “open” state-of-the-art technology. A “Request/Authorize” method for downloadable games has been proposed by another company (IGT's Secure Virtual Network in a Gaming Environment—Publication U.S. 2002/0116615 A1) but the method disclosed therein does not cover how to ensure that only certified authorized components may execute. Although downloadable games are undeniably going to flourish, they have yet to create confidence within the regulatory arena.

Conventional gaming machines are relatively static machines. Indeed, although such gaming machines may allow one or more games to be played, those games do not change, irrespective of the makeup of the potential patrons. Therefore, games and gaming machines that appeal to a younger crowd may not appeal to a relatively older crowd. If the demographics of the patrons is known to shift seasonally or even during the course of a single day, the popularity (and, therefore, gross receipts) of individual games may vary accordingly. Similarly, although the appearance of games and gaming machines is carefully planned, their static nature makes it impossible for them to take the cultural differences of their patrons into account. For example, factors such as culture, age, political affiliation, hobbies, ethnicity, and religious affiliation (to name but a few possible factors) may individually or in combination affect a patron's decision to play or to remain playing a certain gaming machine. Conventional gaming machines are not equipped to take advantage of such factors to increase sales. From the foregoing, it may be appreciated that improved gaming machines, networks of gaming machines and methods of controlling large estates of gaming machines to be responsive to such factors are needed.

### SUMMARY OF THE INVENTION

Embodiments of the present invention overcome the security limitations of the prior art and allow game operators the flexibility to dynamically configure their estate of gaming terminals. It is to be noted that although the gaming industry has coined the term “downloadable game” and that gaming standard GLI-21 entitled “Game Download System” has been published by Game Laboratory International (GLI), the term downloadable game is rather restrictive, as the downloading of software components to computer terminals and computer servers is by itself pervasive in any network distributed computer system. However, downloading certified game components in a secure manner is a problem that has yet to find a satisfactory solution.

Embodiments of the present invention may allocate an individual PKI certificate to each executable software component and each of its versions, binding the PKI certificate to the executable software and associating a distinctive policy for each PKI certificate. The PKI certificate's “Subject Name” (or “Issued to” field, or “CommonName” field) may be a concatenation of the software component identification, its version number and optionally other identification characters, for example.

According to other embodiments, the present invention offers a method to enable dynamic configuration of gaming terminals installed in one or a plurality of gaming premises whereby certified games, certified data files and certified support software components may be activated in accordance with a predetermined schedule or automatically in response to the observed gaming activity. This may be accomplished by configuring and then enforcing the software execution policies for selected PKI certificates in accordance with the desired authorized game configuration and schedule.

Further embodiments of the present invention offer a method to ensure the trust of non-executable files such as initialization or configuration files, video files, sound files, multimedia files, file containing list of hashes, CRCs, and/or signatures. This method relies on the certificate Software Restriction Policy as described herein.

Still further embodiments of the invention enable the certification authority to bind the certificates to the tested software components.

The present invention, according to still further embodiments thereof enables a dynamic generation of the list of games made available to the players without transferring a configuration file or files from the central server to the gaming machines. For example, a method according to an embodiment of the present invention relies on attempting to execute a game component on which a certificate Software Restriction Policy is enforced.

Embodiments of the present invention leverage the technology described in commonly assigned U.S. patent application filing 60/393,892 entitled—“Secure Game Download” in which code signing and Software Restriction Policy enable executing authorized game software. Code signing and Software Restriction Policy (SRP) technologies are available in Microsoft Windows XP, Windows 2000 and Windows 2003, Embedded Windows XP as well as in future Windows versions (as of this writing, the next version is code-named “Longhorn”) to ensure that only executable software components from a trusted publisher, let's say “Microsoft”, are allowed to run. Code signing and Software Restriction Policy technology are applied to executable components such as *.exe, *.dll, *.ocx, *.vbs, *.msi, *.cab, etc. In addition, Software Installation Policy (SIP) ensures that software components are installed in a controlled fashion. Embodiments of the present invention extend the use of code signing, Software Restriction Policy and Software Installation Policy to individual software components that are allowed to execute in a network connected gaming system by associating a distinctive code-signing certificate to each executable software component. Each executable software component version (usually comprising major version, minor version, revision and build) may have a unique certificate. A distinctive certificate may be created for each software component version and the two entities (the compiled code and the certificate) may be bound together by a code signing operation, herein called “signcode.exe”.

Code signed software components may be packaged together with non-signed software components (if any) into a MSI Microsoft installation package (MSI=Microsoft Software Installation). An MSI package is an executable component that in turn receives a distinctive certificate bound to its content by a code signing operation. Only the software component version that has successfully passed the regulatory certification process may be allowed to run by enforcing an unrestricted policy to the associated certificate.

Moreover, embodiments of the present invention extend the use of code signing and Software Restriction Policy to ensure that only authorized non-executable components are used by the authorized executable components. This is of particular value for configuration files or media files that may affect the game outcome such as fixing the return to player at, for example, 95% between 5:00 PM and 11:00 PM, or at 98% during other time periods. For this, non-executable components may be placed in code signed MSI (Microsoft Software Installation) installation packages. Each individual MSI package is an executable component whose execution can be controlled by Software Restriction Policy (SRP). A distinctive certificate may be created for each package version (a part number is created for a preselected aggregate of non-executable components) and the two entities may be bound together by the code signing operation “signcode.exe”. Within the network connected gaming system, trust for non-executable components may be established by executing the associated authorized code signed packages using SRP upon computer startup or alternatively on demand, resulting in the re-installation of the original non-corrupted non-executable components. The non-executable components may be: initialization or configuration files, video files, sound files, multimedia files, file containing list of hashes, CRCs, and/or signatures, for example.

For example, DRM (Digital Rights Management) technology offered by Microsoft Windows Media Player may be used to ensure that only authorized multimedia files may be played or viewed.

Also, RM (Rights Management) technology offered with Microsoft Office 2003, with the associated RM services and SDK (Software Development Kit) may be used to ensure that only authorized data files may be accessed, viewed, copied or modified.

Software Installation Policy (SIP) and Software Restriction Policy (SRP) configured with an individual PKI certificate associated to each authorized software component offer a “Policy/Enforce” model, or in other words a “Configure the Policy and then Enforce the Policy” model to enable network installation (or “game download”) and activation at predetermined times (or “game scheduling”) of selected authorized software components, in order to control the software of the network connected gaming system and offer selected games to players. This “Policy/Enforce” method may be constructed on a demonstrable trusted base; it offers transparent security and fine-grained auditing, contrasting with conventional “Request/Authorize” methods that do not demonstrate reliance on a trusted base to enforce the use of only trusted software components.

A network-connected gaming system comprises hundreds of authorized certified software components that may be selectively downloaded and scheduled. Considering on-going support for 50 customers and for 200 distinctive games over a period of 5 years, tens of thousands of software components will each need to receive individual certificates and be certified. Accordingly, embodiments of the present invention include an automated certification platform. Herein, such a certification platform is denoted “Integrated Certification Environment” or ICE. Embodiments of such a certification platform according to the present invention are designed to automate the stepping through the procedure that must be done by the regulatory certification authority to produce only authorized software components that may be dynamically installed in a gaming system, and to prevent generation of erroneous software components. In addition, the ICE offers support to selectively enable the download of approved system software components using Microsoft Software Update Services (SUS), for example.

Embodiments of the present methods rely on established security standards and a demonstrable trusted base (as opposed to relying on security by secrecy) in order to offer transparent security and allow fine-grained auditing. Embodiments of the present inventions are also applicable to any of the subsystems available in a network connected gaming system that require preventing non-authorized software components from executing or affecting the game outcome, such as the gaming terminals, the game management system (CMS or MCS) that monitor and control whole or part of the estate of gaming machines, the progressive jackpot systems, the bonussing systems as well as game payment verification systems such as IGT's EasyPay and Cyberview's PVU (Payment Verification Unit) and PVS (Payment Verification System). Gaming subsystems may be tested against gaming standards such as those produced by GLI; the game standards are mandated by game regulators in accordance with local regulation and laws. The network-connected subsystems may be located within the premises accommodating the estate of gaming machine (connection via a LAN) or outside of the premises (connection via a WAN).

According to an embodiment thereof, the present invention is a method of operating an estate of a plurality of gaming machines connected to a communication network. The method may include steps of providing a plurality of software games, each of the plurality of software games being configured to implement a predetermined theme on the gaming machines, determining at least one characteristic of at least one player; selecting one of the plurality of software games in accordance with the at least one determined characteristic, and enabling game play on at least one of the plurality of gaming machines, the game play being configured according to the predetermined theme of the selected one of the plurality of software games.

The selecting step may be carried out with the plurality of software games including at least one of selected images, videos, sound files and TV channels to be rendered on at least one video display of each gaming machine. The selecting step may be carried out with the plurality of software games including thematic elements targeted at a predetermined population of players of the plurality of gaming machines. The predetermined theme may be selected according to characteristics including, for example, nationality, ethnic origin, racial identity, geographic origin, favorite hobby, political association, sexual orientation, preferred sport, musical idol or genre, age and/or faith of players of the plurality of gaming machines, to name but a few of the many possibilities. The determining step may include enabling the player(s) to self-select the at least one characteristic through a user interface to render the predetermined theme locally on a gaming machine on which the player(s) is playing. The determining step may include obtaining the at least one characteristic from a player tracking instrument in order to render the predetermined theme locally on a gaming machine on which the player is playing. The player tracking instrument may be selected from a group including, for example, a player loyalty, card and a sign-on ID. The determining step may include enabling a casino employee to select the characteristic(s) on a selected one of the plurality of gaming machines in order to render the predetermined theme on a selected one, some or all of the plurality of gaming machines. The determining step may include enabling a casino employee to select the characteristic(s) on a device coupled to the communication network in order to render the predetermined theme on a selected one, some or all of the plurality of gaming machines. The device may be wirelessly coupled to the communication network, and may be portable.

The player of each of the plurality of gaming machines may carry out the selecting step through a user interface on the gaming machine on which the player is playing. The selecting step may be carried out with the user interface including selectable theme icons. The selecting step may be carried out remotely from the plurality of gaming machines. The determining step may be carried out using video camera monitoring means and video processing means for deriving the at least one characteristic. The video processing means may be included in a central server that may be coupled to one or more of the plurality of gaming machines through the communication network. The determining step may be carried out with the video camera monitoring means being disposed at a gaming machine and the video processing means being disposed at a central server, and the method further may include a step of the video camera monitoring means sending unprocessed video data to the central server over the communication network. The determining step may be carried out using sound monitoring means and sound processing means for deriving the at least one characteristic. The sound processing may be carried out by the sound processing means at a central server that may be coupled to at least one of the plurality of gaming machines through the communication network. The sound monitoring means may be located on at least one of the gaming machines, and the sound processing may be carried out with the sound processing means being disposed at a central server coupled to one or more of the plurality of gaming machines through the communication network. The method further may include a step of the sound monitoring means sending unprocessed sound data to the central server over the communication network. The determining step may be carried out using data mining means to obtain the at least one characteristic from a selected database. For example, the selected database may include one or more of a database of a travel agency containing traveler-related information, and a database of hotel casino guest information, the plurality of gaming machines are disposed within a hotel casino. The travel agency and hotel casino guest information databases may include information related to currently expected, residing and/or departed traveler and/or hotel casino guests, respectively. The determining step may be carried out using detection of a contact-less patron tracking card, as the patrons move about a predetermined area. The predetermined area may include a casino and/or a hotel, for example. The contact-less patron tracking card may include a Radio Frequency Identification Device (RFID) and the determining step may include steps of polling the RFID of the contact-less player tracking card and processing information received from the RFID. The determining, selecting and enabling steps may be executed in a close-loop fashion (such as to optimize patron game activity in real-time, for example). The method may also include a step of dynamically generating a hierarchical menu of games available on a gaming machine on which the player may be playing, the hierarchical menu ranking games being constructed so as to appeal to the player according to the determined characteristics. The hierarchical menu may include themed games and non-themed games to be played on the gaming machine on which the player is playing. The method may further include a step of hierarchically presenting the generated menu in a selected set of recursive pages of submenus and of a collapsible menu list. The menus and submenus may include text lists and/or icons, for example. The providing step may be carried out with the plurality of software games having been certified to comply with applicable game regulatory requirements. The providing step may include downloading the software games over the communication network from a central server under centrally configured installation restriction policies. The enabling step may include enabling the executable files of the software games to execute under centrally configured execution restriction policies. The determining step may be initiated (or carried out) as the player(s) is/are approaching at least one of the plurality of gaming machines. The determining step may be performed or initiated as the player is entering a gaming premise housing the estate of gaming machines. The enabling step may be initiated as the player(s) is/are approaching one or more of the gaming machines. The enabling step may be initiated (or carried out) as the player(s) is/are entering a gaming premise housing the estate of gaming machines.

According to another embodiment thereof, the present invention is a method for dynamically generating on a gaming machine a menu of at least one software game to appeal to a player according to his or her characteristics, the gaming machine being coupled to a communication network and operating as one of a plurality of gaming machines of an estate of gaming machines that are controlled by a central server, the central server enabling at least one executable software component of each software game to execute under centrally configured execution certificate restriction policies. When any software game is selected and played by the player, the method may include steps of binding at least one executable software component of each software game with a pre-selected authorized code-signing certificate, the code signing certificate comprising at least one predetermined theme attribute; enforcing execution restriction policies for the pre-selected authorized code-signing certificate; installing at least one of the software games on the gaming machine; selecting a theme according to the characteristics of the player; inventorying each of the at least one software games and verifying attributes of the associated code signing certificates; determining whether the theme attribute of the code-signing certificate matches the selected theme, and generating a menu of software games whose theme attribute match the selected theme.

According to further embodiments, the generated menu may be presented hierarchically. The method may further include a step of hierarchically presenting the generated menu in, for example, a selected set of recursive pages of submenus and of a collapsible menu list. The menus and submenus may include text lists and/or icons, for example. The predetermined theme attribute(s) of the code signing certificate may include text code concatenated with the certificate subject name and/or a field in the certificate extension. The pre-selected authorized code-signing certificate may be distinct for each executable component of each authorized software game. The selecting step, the inventorying step, determining step and the generating step may be carried out in a close-loop fashion in real-time. The software game(s) may include, for example, selected images, videos, sound files and/or TV channels to be rendered on at least one video display of each gaming machine. The software game(s) may include thematic elements targeted at a predetermined population of players of the plurality of gaming machines. The predetermined theme attribute(s) may be selected according to characteristics including, for example, nationality, ethnic origin, racial identity, geographic origin, favorite hobby, political association, sexual orientation, preferred sport, musical idol or genre, age and/or faith of players of the plurality of gaming machines, to name but a few possibilities. The selecting step may include enabling the player(s) to self-select a theme through a user interface to render the predetermined theme locally on a gaming machine on which the player may be playing. The selecting step may include obtaining the at least one characteristic from a player tracking instrument in order to render the predetermined theme locally on a gaming machine on which the player is playing. The player tracking instrument may be selected from a group including a player loyalty card and a sign-on ID, for example. The selecting step may include enabling a casino employee to select the characteristic(s) on a selected one of the plurality of gaming machines in order to render the predetermined theme on a selected one, some or all of the plurality of gaming machines. The selecting step may include enabling a casino employee to select the characteristic(s) on a device coupled to the communication network in order to render the predetermined theme on a selected one, some or all of the plurality of gaming machines. The device may be wirelessly coupled to the communication network and may be portable. The player of each of the plurality of gaming machines may carry out the selecting step through a user interface. The user interface in the selecting step may include selectable theme icons.

The selecting step may be carried out remotely from the plurality of gaming machines. The selecting step may be carried out using video camera monitoring means and video processing means for deriving the characteristic(s). The selecting step may be carried out with the video processing means being disposed at the central server. The selecting step may be carried out with the video camera monitoring means being disposed on a gaming machine and the video processing means being disposed in the central server. The method further may include a step of the video camera monitoring means sending unprocessed video data to the central server over the communication network. The selecting step may be carried out using sound monitoring means and sound processing means for deriving the characteristic(s). The selecting step may be carried out with the sound processing means being disposed at the central server. The sound monitoring means may be located on at least one of the gaming machines, the sound processing may be carried out with the sound processing means being disposed at the central server, and the method further may include a step of the sound monitoring means sending unprocessed sound data to the central server. The selecting step may be carried out using data mining means to obtain the characteristic(s) from a selected database. The selected database may include, for example, a database of a travel agency containing traveler-related information, and/or a database of hotel casino guest information. The plurality of gaming machines may be disposed within a hotel casino. The travel agency and hotel casino guest information databases may include information related to, for example, currently expected, residing and/or departed traveler and hotel casino guests, respectively. The determining step may be carried out using detection of a contact-less patron tracking card, as the patrons move about a predetermined area, such as a casino and/or hotel, for example. The contact-less patron tracking card may include, for example, a Radio Frequency Identification Device (RFID) and the determining step may include steps of polling the RFID of the contact-less player tracking card and processing information received from the RFID. The software game(s) are preferably certified to comply with applicable game regulatory requirements. The installing step may include downloading the one or more software games over the communication network from the central server under centrally configured installation restriction policies. The selecting step may be initiated as the player(s) may be approaching one or more of the plurality of gaming machines. The selecting step may be initiated as the player(s) enter the premises housing the estate of gaming machines. The selecting step may be initiated as the player(s) approach one or more of the plurality of gaming machines.

The installing step may be performed with software game(s) packaged within a code signed MSI installation package that are downloaded to the gaming machine through the communication network. The software game(s) may be allowed to be installed via enforced certificate policies configured centrally applied on the code signed MSI installation package. Each MSI installation package may be code signed with a distinctive PKI certificate.

### BRIEF DESCRIPTION OF THE DRAWINGS

FIG. 1 illustrates the intrinsic information that uniquely identifies each executable software component, according to an embodiment of the present invention.

FIG. 2 illustrates the information uniquely identifying each executable software component being made available into the Windows Event Log upon execution of the software component, according to an embodiment of the present invention.

FIG. 3 illustrates the information (test certificate indicator, project/product code, type of executable code, part number, major/minor/build/version, certification lab identifier, friendly name) uniquely identifying each executable software component being used to generate the “Subject Name” (or “Issued to” field, or “CommonName” field) of the individual PKI certificate associated to each executable software component, according to an embodiment of the present invention.

FIG. 4 illustrates the information that may be entered in the Extended Attributes of a PKI certificate, according to an embodiment of the present invention.

FIG. 5 illustrates the information that may be obtained using the Trusted Inventory tool, according to an embodiment of the present invention.

FIG. 6 illustrates the information that may be entered to configure a type-certificate Software Restriction Policy rule, according to an embodiment of the present invention. A Software Restriction Policy (SRP) is configured using the Group Policy Object Editor.

FIG. 7 illustrates the policies that are associated to the active directory container used to configure the gaming machines, according to an embodiment of the present invention.

FIG. 8 illustrates an exemplary cycle from the moment a game is being created until it is first executed on a gaming terminal, according to an embodiment of the present invention.

FIG. 9 illustrates the global verification process performed by the terminal in order to check that no unauthorized file may execute or may affect game outcome, according to an embodiment of the present invention.

FIG. 10 illustrates the configuration of the three parties involved in a new game cycle detailed at FIG. 8, according to an embodiment of the present invention.

FIG. 11 illustrates the 12 folders created on the disk repository of the development environment, according to an embodiment of the present invention.

FIG. 12 illustrates the dataflow for step 1 to step 3 for producing the certified authorized software components, according to an embodiment of the present invention.

FIG. 13 illustrates the dataflow for step 4 to step 12 for producing the certified authorized software components, according to an embodiment of the present invention.

FIG. 14 illustrates the grouping of gaming terminals and the associated enforced policies, according to an embodiment of the present invention.

FIG. 15 illustrates a method for enforcing a Software Installation Policy by “linking” the policy, according to an embodiment of the present invention.

FIG. 16 illustrates a method for enforcing a Software Restriction Policy by “linking” the policy, according to an embodiment of the present invention.

FIG. 17 illustrates the method to enforce a policy at a predetermined time, according to an embodiment of the present invention.

FIG. 18 illustrates the method to enforce a selected policy as the result of observing the gaming activity, according to an embodiment of the present invention.

FIG. 19 illustrates the method to generate dynamically the menu list of authorized game made available to the player on each gaming terminal, according to an embodiment of the present invention.

FIG. 20 illustrates the method to generate a code signed companion software component, according to an embodiment of the present invention.

FIG. 21 illustrates the method to quickly generate dynamically the list of game installed on each gaming terminal using the companion software component, according to an embodiment of the present invention.

FIG. 22 shows a network of gaming machines, according to another embodiment of the present invention.

FIG. 23 shows an example of a themed game suitable for game play on one or more of the gaming machines of FIG. 22.

FIG. 24 shows another example of a themed game suitable for game play on one or more of the gaming machines of FIG. 22.

FIG. 25 shows an exemplary themed gaming machine, according to an embodiment of the present invention.

FIG. 26 illustrates a method for dynamically generating a menu list of authorized game to be made available to the patron, according to an embodiment of the present invention.

FIG. 27 shows an embodiment of a method for monitoring gaming machine patrons and for modifying the games and/or themes made available in real time, based upon the results of the monitoring.

### DETAILED DESCRIPTION

Reference will now be made in detail to the construction and operation of preferred implementations of the present invention illustrated in the accompanying drawings. The following description of the preferred implementations of the present invention is only exemplary of the invention. The present invention is not limited to these implementations, but may be realized by other implementations.

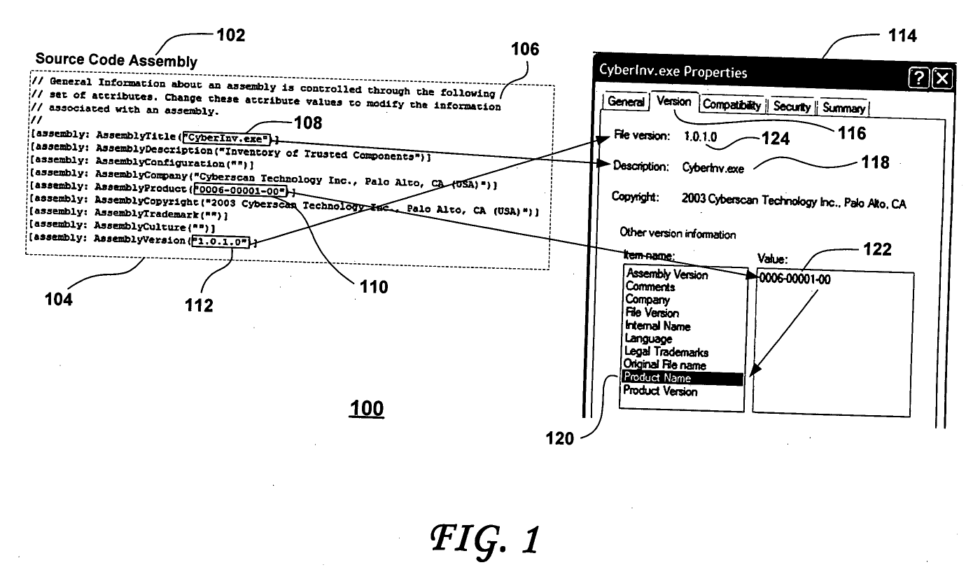

FIG. 1 illustrates Software Component Identification and Traceability via File Properties, according to an embodiment of the present invention. Shown at 100 in FIG. 1 is the intrinsic information that uniquely identifies each executable software component. The executable component source code comprises executable code lines (e.g. X=X+1; not shown here) and associated source code assembly information 102, 104 that comprises comment lines 106 and assembly information. Herein, AssemblyTitle 108, AssemblyProduct 110 and AssemblyVersion 112 are configured. The AssemblyTitle 108 is set to CyberInv.exe that is the friendly name of the executable software component; AssemblyProduct 110 is set to 0006-00001-00 that is the part number of the executable software component and AssemblyVersion 112 is set to 1.0.1.0, which is the version number of the executable software component. Once the source code is compiled and the executable is built (CyberInv.exe in this case), the configured assembly information is available via the File Property of Windows 114 when right clicking on the file CyberInv.exe and selecting “Properties” and “Version”, as shown at 116. The friendly name is shown in the Description field 118, the part number is shown in the Product Name field 120, 122 and the version is shown in the File Version field 124.

It will be apparent to those of skill in the art of software development that intrinsic information that uniquely identifies each executable software component may be obtained in various combinations of assembly directives and file property fields. Additional information may be configured such as, for example, the software component part number, major version number, minor version number, build number, revision number, project name, type of software component, language variant, game regulation variant, friendly name, identification of the certification laboratory, identification of the client, and other predetermined identification identifiers. The identifiers associated with the executable software component using source code assembly directives may, therefore, be traceable via the File Property features of the Windows operating system.

An example of such a configuration is CST3000-0006-00001-00 [1.0.1.0]{21}ˆ11˜9% S CyberInv.exe that comprises a concatenation of identifiers that may be used in a file name or a PKI certificate subject name. According to this example, CST3000 is the marketing system product identification or the project name; 0006-00001-00 is the software component part number; [1.0.1.0] details the software component major version number, minor version number, build number, revision number; {21} is the software component variant identifier; ˆ11 identifies the certification lab that certifies the software component; ˜9 identifies the customer for which this software component is certified; % S is the software component language variant (“S” for Spanish in this example); CyberInv.exe is the software component friendly name for quick identification. Spaces may be used freely and the identifier fields may be written in any order so as to facilitate reading. Identifier fields may be omitted whenever the context already provides such information. The framing or delimiter characters such as [ ], { }, ˜, ˆ, % which are allowable characters to be used in file names and certificate subject names facilitate human recognition as well as string searches for particular attributes (global search for all Spanish variants for example).

In the same manner, a selected set of identification information making up the certificate subject name may be used for making up the file name of PKI certificate related files such as *.CER, *.P7B and *.PVK such as to facilitate human identification, string searches and file searches.

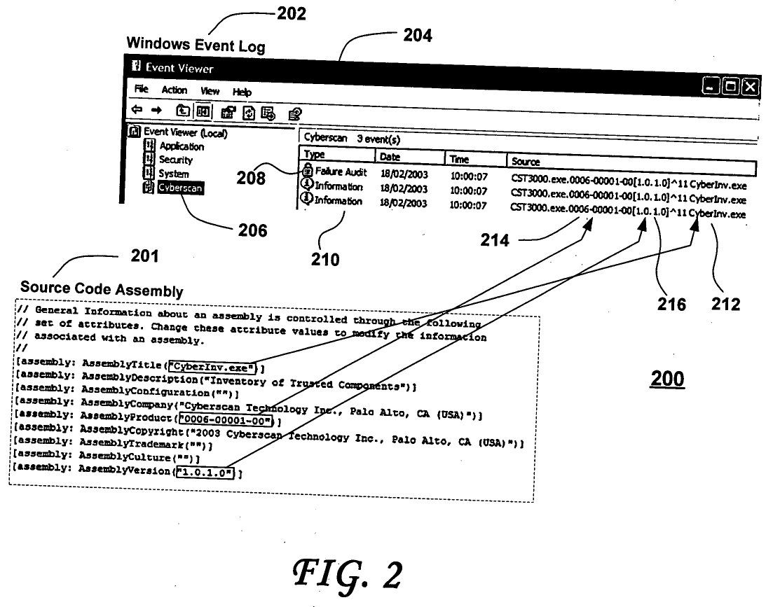

FIG. 2 illustrates traceability via the Windows Event Log. Reference numeral 200 in FIG. 2 illustrates the information uniquely identifying each executable software component being made available to the Windows Event Log upon execution of the software component. The Windows Event Log 202 is a repository for logging important events; it is viewed via the Event Viewer 204. Windows default event log bins (or containers) are Application, Security and System. In the illustrated example, an Event Log bin 206 denominated “Cyberscan” has been added. The Cyberscan bin 206 contains traceability information in its “Source” field that is being logged by each of the executable software components. The software executable software component makes use of the Event Log API to “splash” its identification information into the source field of a predetermined bin in the Windows Event Log each time it starts execution, or at any other time should the occurrence of an event be traced, in order to provide an audit trail to be examined by auditors. The part number 214, version 216 and friendly name 212 identifiers associated to the executable software component using source code assembly directives 201 are therefore traceable via the Event Log features of the Windows operating system. Other information associated with the executable software component may be splashed into the event log for additional traceability. The “Type” field 208 may flag an important audit condition such as here “Failure Audit” to alert the auditor.

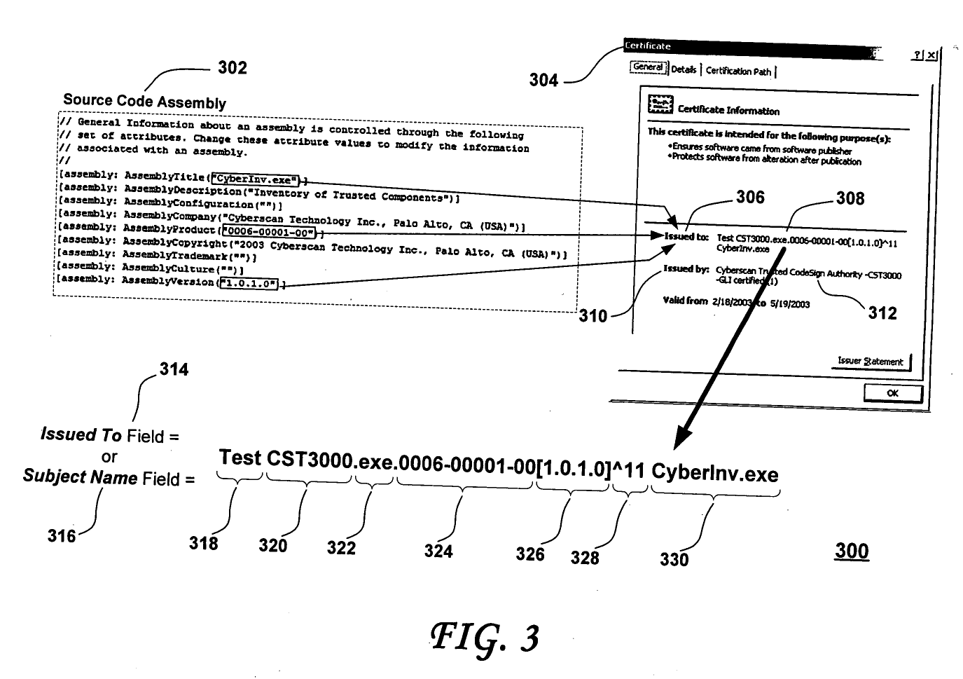

FIG. 3 illustrates the Certificate “Issued to” Field. Reference numeral 300 illustrates the information 308 (test certificate indicator 318, project/product code 320, type of executable code 322, part number 324, major/minor/build/version 326, certification lab identifier 328, friendly name 330) uniquely identifying each executable software component being used to generate the “Subject Name” 316 (or “Issued to” field 306, 314, or also known as the “CommonName” field) of the individual PKI certificate 304 associated with each executable software component, according to an embodiment of the present invention. The friendly name, part number and version of the executable software components may be substantially identical to those entered in the source code assembly 302. “Subject Name” 316 and “Issued to” field 306, 314 refer to the same information; Subject Name is preferably used hereafter. The certificate authority 312 responsible for generating the PKI certificate is shown in the “Issued by” field 310.

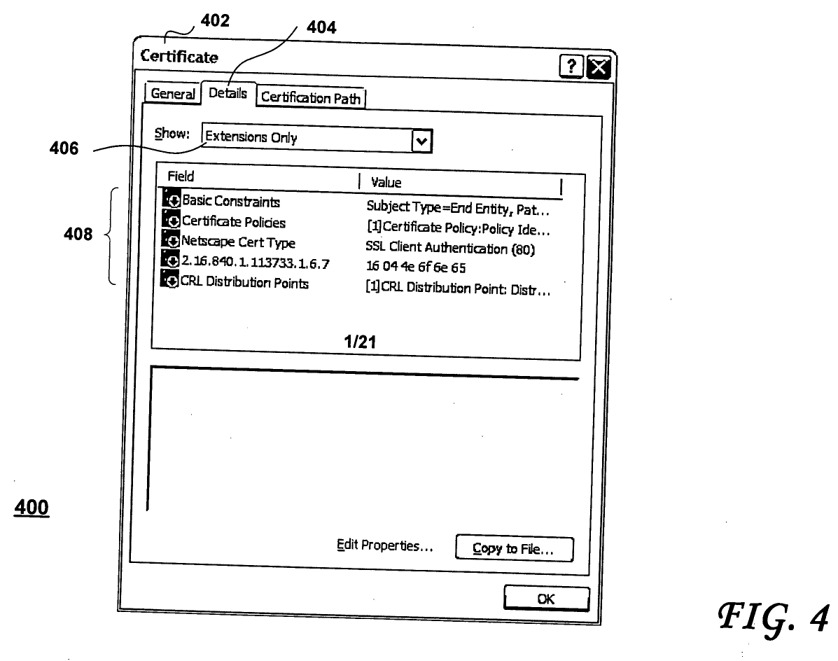

FIG. 4 at 400 illustrates the information that may be entered in the Extended Attributes 408 of a PKI certificate 402, according to an embodiment of the present invention. This information may be viewed by selecting, for example, the “Details” tab 404 of the certificate 402 and selecting “Extensions Only”, as shown at 406. Intrinsic information that uniquely identifies each executable software component may be entered in the extended attributes of a PKI certificate in order to attain the same purpose as described for FIG. 3 as an alternative to entering the information in the certificate Subject Name. In the same manner, additional identification information to those entered in the Subject Name may be entered in the extended attributes.

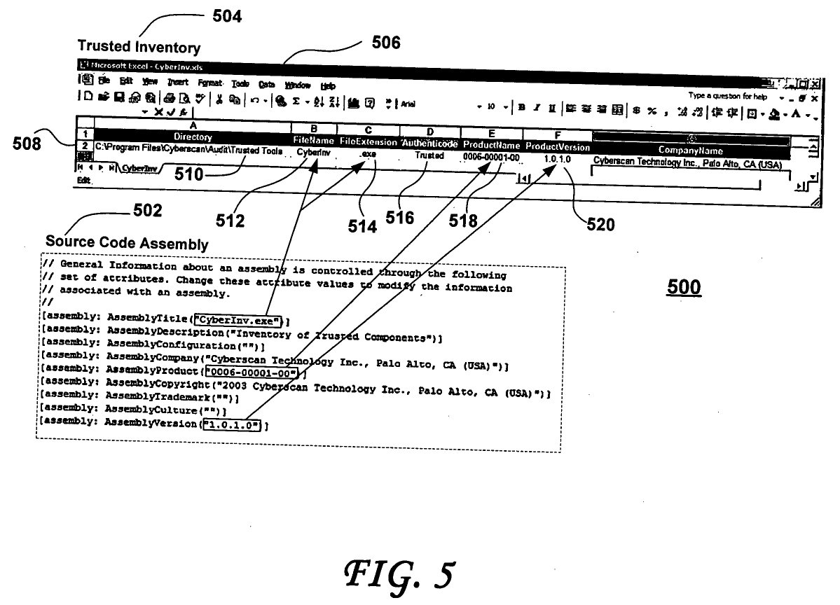

FIG. 5 illustrates traceability via the Trusted Inventory Tool 504, according to an embodiment of the present invention. Reference numeral 500 in FIG. 5 illustrates the information that may be obtained using the Trusted Inventory tool 504. The trusted inventory tool 504 is a simple application that searches for executable files through the branches of a given tree directory and determines whether the executable software component may be trusted by, for example, calling the Microsoft ChkTrust.exe tool. If the executable software component is signed by a valid PKI certificate and its executable binary data is uncorrupted (its recalculated hash matches the code signature), the ChkTrust.exe tool returns the authenticode “Trusted” attribute; an “Untrusted” attribute is returned otherwise. The Trusted attributes are automatically tabulated in a spreadsheet such as, for example, Microsoft Excel as depicted at 506. Each line 508 in the table provides details on the executable software component that is being examined, such as program path location 510, friendly name 512, executable type 514, authenticode trusted attribute 516, part number 518 and version 520. According to an embodiment of the present invention, therefore, the part number 518, version 520 and friendly name 512 514 identifiers associated with the executable software component using source code assembly directives 502 are traceable via the Trusted Inventory tool.

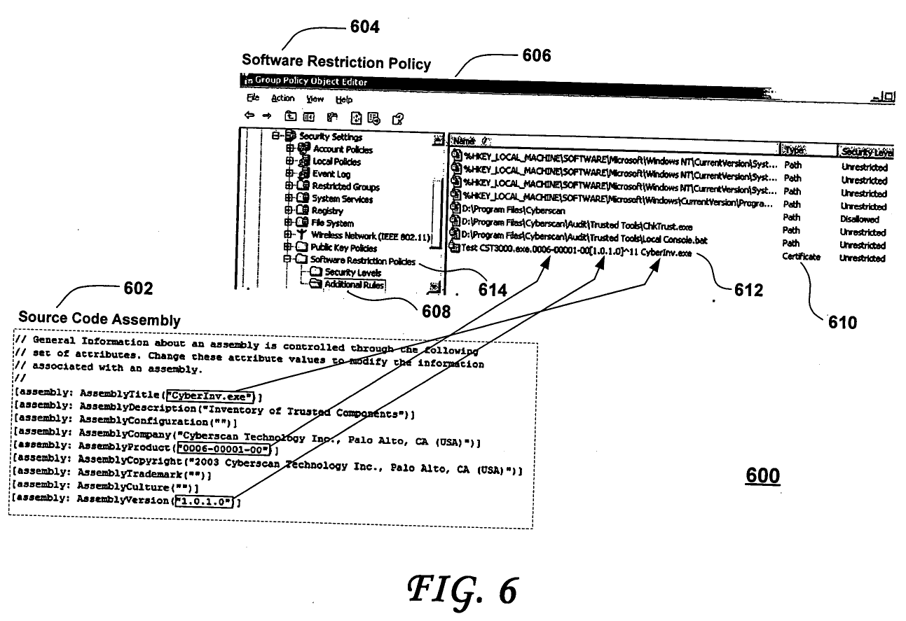

Reference numeral 600 in FIG. 6 illustrates the information that may be entered to configure a type-certificate Software Restriction Policy rule. A Software Restriction Policy (SRP) 604 may be configured using the Group Policy Object Editor 606. The type-certificate Software Restriction Policy rule 610 may be entered in the “Additional Rules” node 608 of the Software Restriction Policy object 614. In FIG. 6, the part number, version and friendly name configured in the source code assembly 602 are recognizable in the certificate subject name 612.

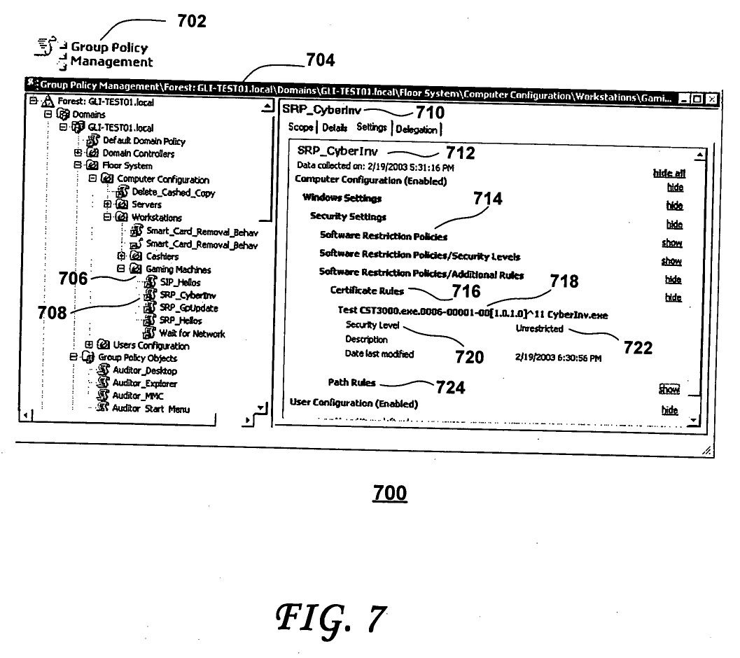

FIG. 7 illustrates SRP Certificate Rules Policies via the Group Policy Management Console, according to an embodiment of the present invention. Reference numeral 700 in FIG. 7 illustrates the policies that are associated to the active directory container used to configure the gaming machines referenced at 706. Policies are managed using the Group Policy Management Console 702, 704. In this illustration, a policy named “SRP_CyberInv” 708, 710, 712 is selected, for the purpose of viewing a detailed report of the rules that are configured. The report shows details in a hierarchical order. This exemplary policy defines only one certificate rule 716 in the Software Restriction Policy node 714. The certificate subject name 718 is set with a security level 720 of “Unrestricted”, as shown at 722, thus ensuring that only the executable software component identified in the certificate subject name is authorized to execute when the policy 714 is enforced. The SRP path rules 724 must be configured such as to prevent non-authorized software from executing. The policy 708 is enforced when it is linked to its container object 706 herein named “Gaming Machines”.

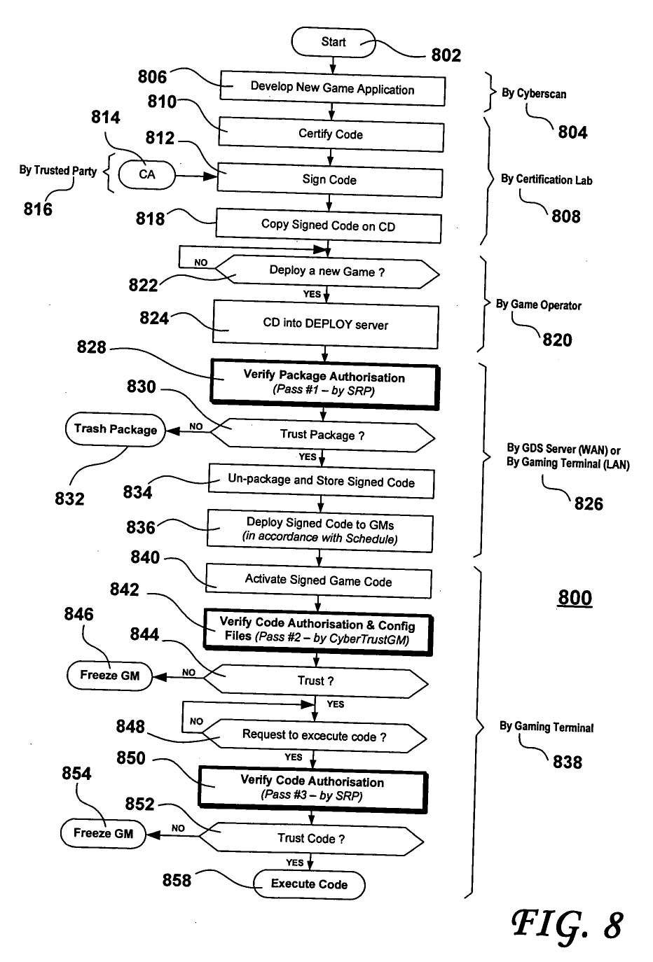

Reference numeral 800 in FIG. 8 illustrates an exemplary cycle from the moment a game is being created until it is first executed on a gaming terminal, according to an embodiment of the present invention. The flowchart 800 starts at 802 when the decision to initiate a project to develop and release a new game is made. The game developer (Cyberscan here, for illustrative purposes only) 804 develops a new game application 806 whose code must be certified at 810 by a recognized certification lab 808. The certified code must then be signed as shown at 812 using PKI certificates produced by a certificate issuing authority (CA) 814 controlled by a trusted party 816. The trusted party 816 may be the certification lab 808. The signed executable software components may be packaged in code-signed MSI installation packages signed in a manner substantially identical to the executable software components, that is, with a unique PKI certificate whose subject name contains part number, version and friendly name identifiers for the MSI package. The MSI packages together with scripts may then be copied to a removable media, such as a CD-ROM 818 for example.

The game operator 820 receives the CD-ROM and when it decides to deploy the new game 822, it copies the packages and associated scripts from the removable media into a library repository on a server 824 (the DEPLOY server in this case). The scripts contain automation tasks such as copying to the repository and configuring the policies.

In the case of gaming terminals connected in a LAN, each gaming terminal 826 is controlled by the policies as soon as they are enforced. The Software Installation Policies (SIPs) controlling the installation of the new game automatically execute the MSI installation packages upon policy enforcement, provided the corresponding Software Restriction Policies have been configured to authorize the execution of the MSI installation packages. This process is performed at 828, 830. If no SRP authorizes the execution of the MSI installation packages, the installation is ignored, as shown at 832. When the MSI installation package is authorized to execute, the software components and other files contained in the package may be copied to the gaming terminals, as suggested at reference numeral 834 836. Other configuration tasks may also be carried out during the Microsoft installer installation process such as, for example, setting the Windows registry, setting shortcuts and installing software patches.

Download of the game software components from the game repository to the gaming terminals may occur as soon as the associated Software Installation Policies are enforced (and the SRPs for the MSI installation package is permitted accordingly). Therefore, scheduling of the download may be achieved by simply enforcing the associated software installation policies at a given time; this may be accomplished by having an operator manually enforcing the SIP at a predetermined time via the group policy management console, or having a process automatically enforcing the SIP at a predetermined time via the API to the group policy management console. Enforcing a policy may be achieved by linking the selected policy to the selected policy object in the domain controller active directory.

Game activation 840 that authorizes execution of the game may be achieved by enforcing the associated Software Restriction Policies. In the same manner, scheduled game activation and deactivation in order to offer selected authorized games to the players at predetermined authorized times may be achieved by simply enforcing the associated Software Restriction Policies at a given time; this may be accomplished by having an operator manually enforce the SRP at a predetermined time via the group policy management console, or having a process automatically enforce the SRP at a predetermined time via the API to the group policy management console. Enforcing a policy may be achieved by linking the selected policy to the selected policy object in the domain controller active directory. Alternatively, a selected executable software component may be prevented from executing by configuring its associated SRP security level to “disallowed”.

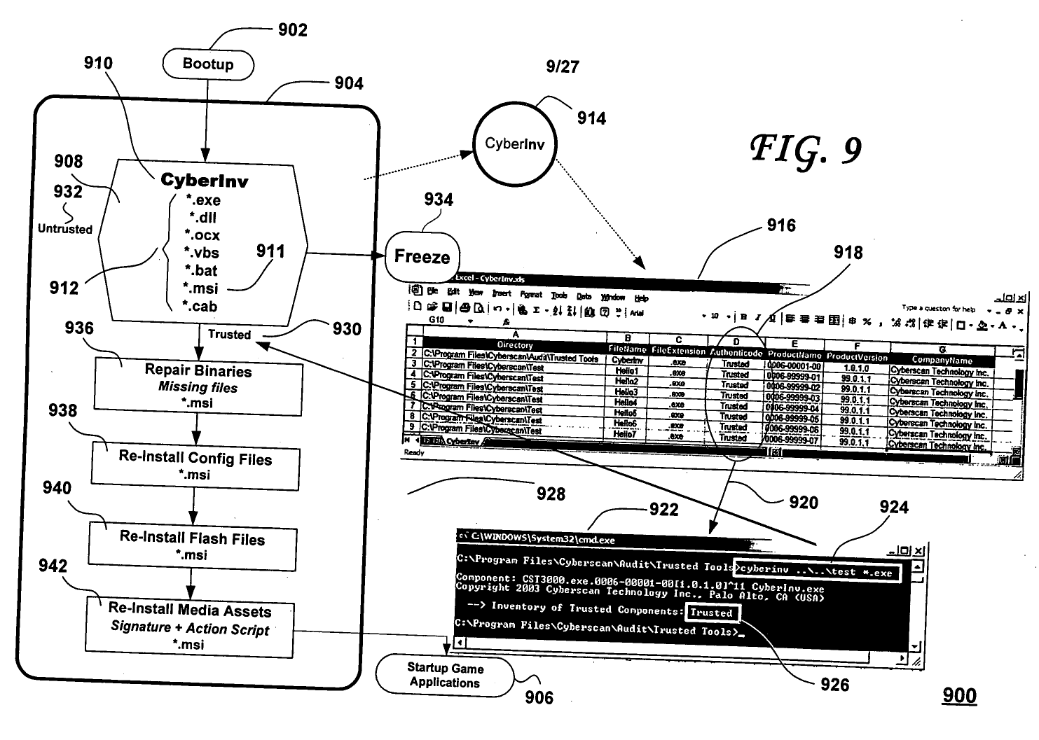

At this stage, a global verification process 842, 844 as described relative to FIG. 9 may advantageously be executed to verify the trust of every software component installed on the gaming terminal. Should the global verification fail, the gaming terminal may be locked at 846 pending servicing by an attendant.

When a player selects a game from a gaming terminal 838 from a selection menu and requests execution thereof, as shown at 848, the authenticodes of the game's executable software components are verified by the associated enforced Software Restriction Policy as shown at 850 before beginning execution 858. Should the authenticode verification fail at 852, the gaming terminal may be locked at 854 pending servicing by an attendant. If the code is trusted, as verified by the associated enforced SRP, the game is allowed to execute, as shown at 858.

Policy changes are automatically distributed by the Windows server operating system throughout the network connected gaming system at periodic intervals; this automatic process may be disabled if required. Alternatively, the RegisterGPNotification function may be used by the game application software executing on each gaming terminal to check if an applicable group policy has changed. The gaming terminal may then decide on enforcing the policies locally immediately. The gpupdate.exe service, the RefreshPolicy function or the RefreshPolicyEx function may be used by the game application software executing on each gaming terminal to enforce the configured policies. A reboot may optionally be performed in order to recheck the gaming terminal trusted base and ensure the policies have been completely enforced (long game installation for example).

The RegisterGPNotification function enables an application to receive notification when there is a change in policy. When a policy change occurs, the specified event object is set to the signaled state. Further information on the RegisterGPNotification function may be found at: http://msdn.microsoft.com/library/default.asp?url=/library/en-us/policy/policy/registergpnotification.asp. The RefreshPolicy function causes policy to be applied immediately on the client computer. Further information on the RefreshPolicy function may be found at: http://msdn.microsoft.com/library/default.asp?url=/library/en-us/policy/policy/refreshpolicy.asp. The RefreshPolicyEx function causes policy to be applied immediately on the computer. The extended function allows specifying the type of policy refresh to apply to be specified. Further information on the RefreshPolicyEx may be found at http://msdn.microsoft.com/library/default.asp?url=/library/en-us/policy/policy/refreshpolicyex.asp.

The menu of authorized games offered to the player may be dynamically generated by each terminal without requiring the central system to dispatch the list of authorized games or having each terminal fetch the list of authorized games from the central system; this may be done by having each terminal check the policies enforced on the games. This may be accomplished by having a process in each terminal attempt to execute each of the entry point for each game (the parent module which is first called upon selecting a game to play). If the execution succeeds, then the game is authorized and may be added to the games menu offered to the player. If the execution is denied (SRP is unlinked or the security level is disallowed), then the game is not authorized and it is removed from the games menu offered to the player. Similarly, if a game entry software component file is not found, then the software is not installed or has been removed and is removed from the games menu offered to the player. The process of dynamically generating the game selection menu may be optimized in many ways in order to reduce the game time to start overhead to check if it is authorized.

In a casino, although new games may be scheduled to be downloaded to gaming terminals and activated at predetermined times, it is a requirement that games may not be changed while a player is playing. In practical terms, a player is considered to have terminated his or her game play when the player's credit balance remains at zero for a predetermined period of time. The predetermined period time is sufficient for allowing the player to enter a new bill or other form of credit instrument to continue playing. Therefore, the game application software on each game terminal may, according to embodiments of the present invention, continually test for this condition (credit=0 for a predetermined time) before checking for change in policy, enforcing the policy changes and then updating the menu of games to be made available to the next player.

FIG. 9 at 900 illustrates the global verification process performed by a terminal to check that no unauthorized files are allowed to execute or affect the game outcome. This process may be performed by any of the subsystems connected in the gaming systems.

The process may start with a computer cold or hot reboot 902 such that the operating system trusted base may be thoroughly verified before the game software components are verified. The trusted base is detailed in commonly assigned and copending US application serial number PCT/US2002/029927, entitled “Secure Game Download”, attorney docket—CYBS5819, the specification of which is incorporated herein by reference, and also in Microsoft Next Generation Secure Computing Base (NGSCB), also incorporated herein by reference. Details of Microsoft's NGSCB are located at www.microsoft.com/ngscb. During the trusted base verification, the integrity of the Driver Signing framework, the Windows File Protection framework and Software Restriction Policies framework are verified. With NGSCB operating system such as forthcoming “Longhorn”, a framework called Nexus deeply integrated directly within the hardware components (in each major chipsets) and the BIOS which constitutes a mechanism for authenticating the trustworthiness of the software and hardware configuration, is booted prior to checking the integrity of the Driver Signing framework, the Windows File Protection framework and Software Restriction Policies framework.

On completion of the operating system boot-up 902 or at another time, the global verification process 904 may be executed. The CyberInv process 910, 914 is also shown and described at FIG. 5. The CyberInv process 910, 914 verifies all the executable files in given folder trees such as 912 (*.exe, *.dll, *.ocx, *.vbs, *.bat, *.msi, *.cab, for example) for trustworthiness. If any file is found to be untrusted as shown at 932, then the gaming terminal may be frozen as shown at 934 pending examination by security personnel. A spreadsheet file 916 may be produced that list the verification status of each executable file. If the authenticode of all the files is trusted as shown at 918 then the CyberInv process 908, 910, 914, 924 returns at 920 a trusted status, as shown at 926 930. Consequently, all of the executable software components may be considered to be trusted, as shown at 930.

However, it is to be noted that the fact that an executable software component is trusted does not imply that the software component is authorized to execute; it merely indicates that the software executable software component has a valid authorized authenticode certificate and that the software component binary data is not corrupted. Checking whether an executable software component having a valid authorized authenticode certificate is authorized to execute requires that the applicable Software Restriction Policy be checked. This may be performed automatically when the software component is loaded by the operating system to start its execution, either when dynamically building the menu of authorized games, or each time upon starting execution of the game when the player has selected a game to play—or using an appropriate service that may be called by an application.

Although RM (Rights Management) and DRM (Digital Rights Management) technology from Microsoft is readily available for authenticating the trustworthiness of non-executable files such as media files, Word files and emails, for example, it adds management complexity on top of the Software Restriction Policy framework when used in a network-connected gaming system. Addressing this, embodiments of the present invention offer a method for a network connected gaming system to trust non-executable files such as initialization or configuration files, video files, sound files, multimedia files, file containing list of hashes, CRCs, and/or signatures. The present method relies on packaging the non-executable files in a MSI installation package, the MSI package being subsequently code-signed with a unique certificate and the appropriate Software Restriction Policy is configured to enable installation (execution in fact) of this MSI package. Executable files and non-executable files may be packaged together for convenience. The selected aggregate of executable files and non-executable receives at least a part number (and preferably a version number as well) that is used in the subject name of the associated certificate. Consequently, according to embodiments of the present invention, when the MSI package is installed, the installed non-executable files are obtained from a trusted and authorized source.

As the CyberInv process 908 has authenticated the trustworthiness of all the *.msi files 911, therefore whenever there is a need to ensure that the non-executable files are trusted, the associated MSI package is re-installed. It is to be noted that the service that performs the installation of the MSI packages (msiexec.exe in the current versions of Windows) may be executed with a variety of execution modifiers, such as shown at http://www.microsoft.com/technet/treeview/default.asp?url=/technet/prodtechnol/winxppro/proddocs/msiexec.asp. Of particular interest is the c option that reinstalls a file if it is missing or if the stored checksum of the installed file does not match the new file's value (the log file will contain the anomalies detected for subsequent forensic analysis), as shown at 936. In the global verification process 904, the c option of the msiexec.exec command may be used for re-installing every package containing configuration files 938 (such as initialization or configuration files, files containing list of hashes, CRCs, and/or signatures), Flash files 940 (Macromedia Flash and Director), and other media assets files 942 in order to ensure the trustworthiness of these files.

Subsequent to completion of process 908, all the MSI packages for the executable software components may be re-installed with for example, the msiexec.exe command using the p option in order to re-install missing authorized executable software components (the log file will contain the anomalies detected for subsequent forensic analysis).

Subsequent to the successful completion of the global verification process 904, the trustworthiness of the game application framework is established and may be started, as shown at 906.

It is to be noted that when a player wins an amount equal to or greater than $25,000 in a casino, there is a requirement to check the integrity of the gaming application. With legacy gaming terminals, the gaming terminal is powered-down and the ROMs are extracted in order to be verified in a trusted verifier named a “Kobetron”. The Kobetron produces a signature for each of the ROMs that is compared with the corresponding signature produced by the certification lab. In this manner, the integrity of the all the software components of the legacy gaming terminal, including the operating system, the game application and the configuration data may be verified. According to embodiments of the invention, when executing the global verification process 904 subsequent to the gaming terminal bootup at 902, a verification equivalent to a “Kobetron verification” may be performed. This metaphor helps greatly in the acceptability of downloadable game technology by game regulators who are reluctant to accept state-of-the-art operating systems, multimedia and network technologies.

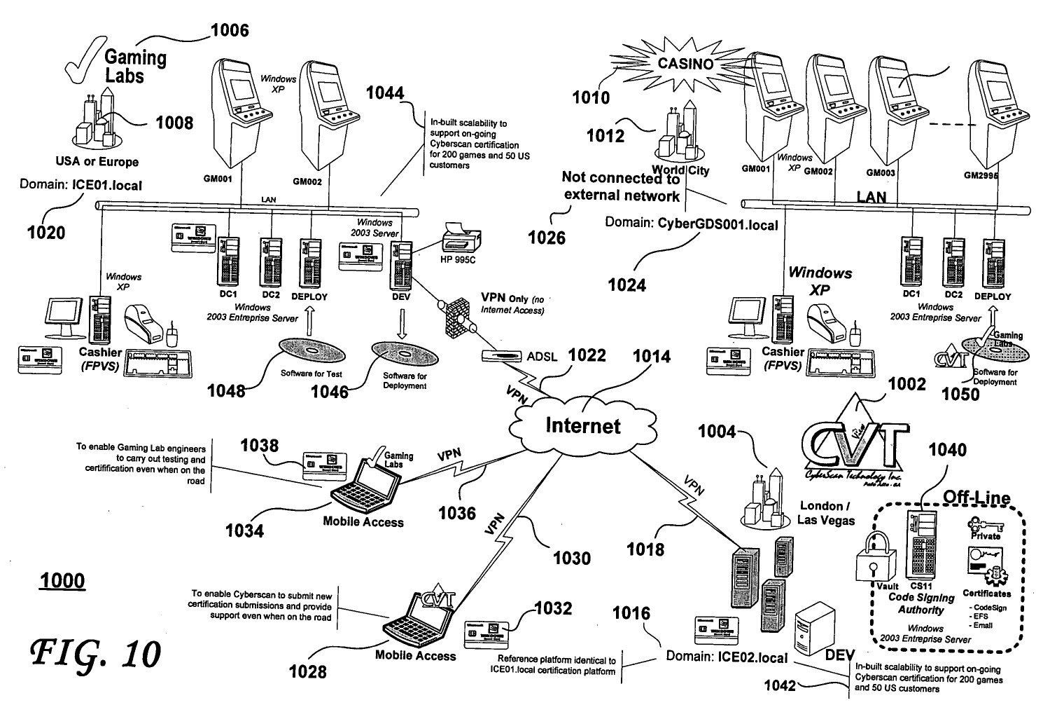

FIG. 10 at 1000 illustrates the configuration of the three parties involved in a new game cycle detailed at FIG. 8, according to an embodiment of the present invention. The three parties involved in a game cycle, according to embodiments of the present invention, are the game developer 1002 whose facilities are located in a given city 1004, the certification laboratory 1006 whose facilities are located in a given city 1008 and the gaming operator 1010 located in a given city 1012. The game developer 1002 and the certification lab 1006 may have a network 1020 of connected gaming system(s) representative of the network connected gaming system in place at the location (e.g., the casino) of the gaming operator 1010. In addition, the game developer 1010 and the certification lab 1006 each may have an integrated software development environment for compiling the game applications source code, each capable of managing at least 200 games for 50 distinct game operators as shown at 1044, (resulting in thousands of source code variants due to local regulation variances). The development environments may be kept synchronized via the secure network link 1016, 1018, 1014, 1022, 1020. A certification authority (CA) 1040 may be located at the game developer's site or may be controlled by an authorized trusted party such as VeriSign. The game developer site and the certification lab site may be accessible from the outside by authorized mobile users 1034, 1028 via secure links 1022, 1018, 1030, 1036. Logon authentication may be carried out using, for example, smartcards as shown at 1038, 1032 or by other secure means.

The game developer 1002 supplies the certification lab 1006 with a CD-ROM (or other media) containing the software components to be tested, as shown at 1048. The certification lab then certifies the software components supplied on the CD-ROM and provides the game developer 1002 with a CD-ROM containing the certified software components for deployment, as shown at 1046. The CD-ROM 1046 containing the authorized software components that were tested and certified by the certification lab 1006 may then be provided to the game operator (e.g., the casino) for installation and deployment on one or more of the gaming machines GM001, GM002, GM2995 coupled to the network 1024. The certified authorized software components are code-signed using a certificate produced in accordance with an embodiment of the present invention, as described hereinabove. The network 1024 is preferably not coupled to any external network, as suggested at 1026.

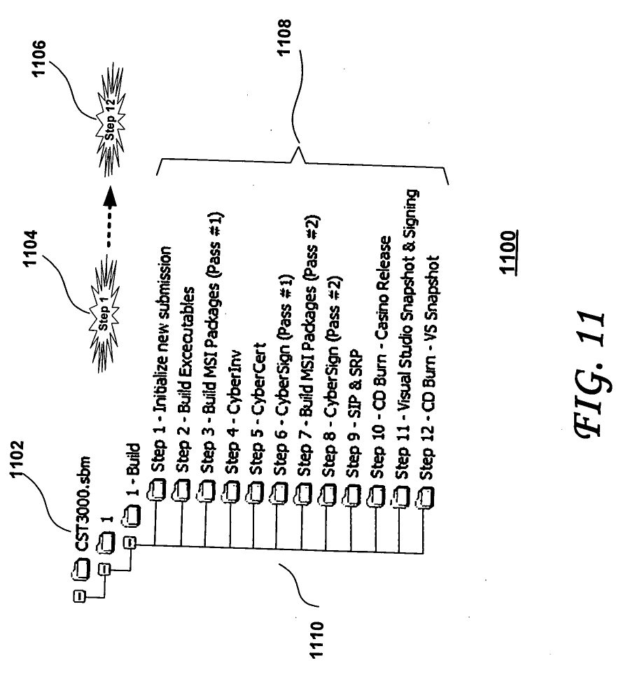

FIG. 11 shows a 12-Step Integrated Certification Environment Process, according to an embodiment of the present invention. Shown at 1100 are the 12 folders 1110 created on the disk repository 1102 of the development environment. The 12 folders 1110 are mapped to the 12-step procedure 1104 to 1106 involved in producing the CD-ROM 1050 containing the certified authorized software components. Each folder contains the computer resources and instructions to carry out each step. The folders are clearly named with the step number and the title description of the procedure step at 1108.

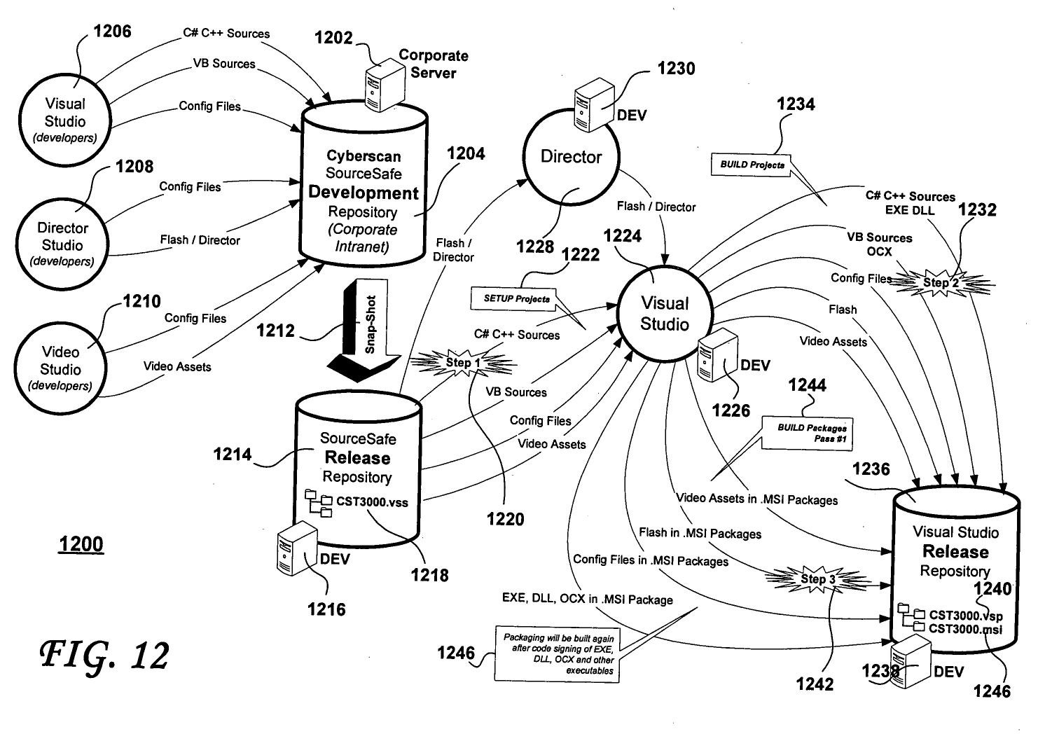

FIG. 12 shows a dataflow diagram of Step #1 to Step #3 of the Integrated Certification Environment Processor for producing certified authorized software components, according to an embodiment of the present invention. Step 1 at 1220 may include obtaining a snapshot 1212 of the repository 1204 containing the game developer's source code 1206, data files 1208 and media assets 1210 in order to configure the building environment of the reference platform with all the source code, data files, media asset files and resources files required to initiate the certification process. The snapshoot files 1212 may be stored in a repository 1218 controlled by a version configuration and control system (SCCS) such as Microsoft Visual Source Safe 1214 (VSS) on the DEV development computer 1216. The files may be grouped in project directories as “Projects” such that the source files, control files and resource files are stored in convenient systematic fashion in the Visual Studio repository 1240 on the development computer 1238. An inventory of the files submitted for certification may be produced. Step 1 may be qualified as “SETUP Projects” 1222.

Step 2 at 1232 may include compiling the source code and producing binary executable code. Microsoft Visual Studio 1224 is constructed so as to manage source code as projects (a project can be a given game) regrouping all of the dependent source code, and data files. Step 2 is also referenced as building the projects or “BUILD Projects”, as shown at 1234. Media assets may require a different compiling environment on the DEV computer 1230 such as the Macromedia Director 1228.

Step 3, shown at 1242 may include producing the projects MSI packages 1244 for the source code compiled in Step 2. Relevant non-executable file such as configuration files and media assets may be packaged in MSI packages with the compiled source code. It is to be noted 1246 that packages will be built again (step 8 hereafter) after code signing of EXE, DLL, OCX and other executables (step 6 hereafter). Step 3 may be referenced as “BUILD Packages Pass #1” 1244.

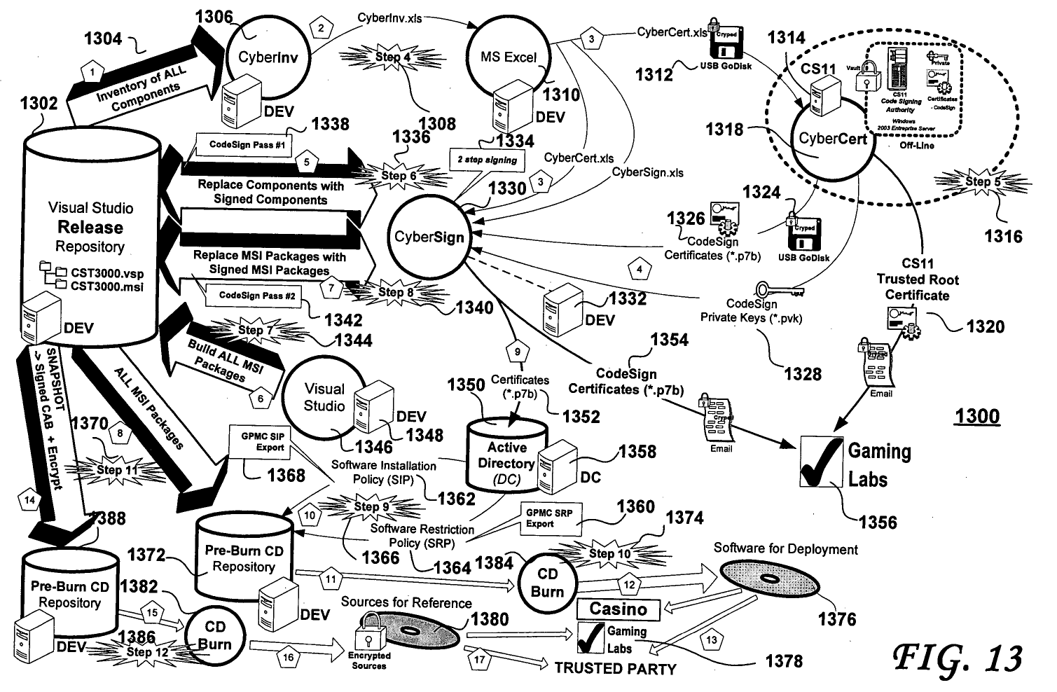

FIG. 13 shows, at 1300, the dataflow for step 4 to step 12 for producing the certified authorized software components, according to an embodiment of the present invention. Step 4 at 1308 calls for the CyberInv.exe process 1306, for a selected project (a Visual Studio project may typically regroup all the software components for an entire game), perform an inventory 1304 of the compiled software components produced by Visual Studio 1302 on completion of the Build Project process 1234 (FIG. 12) as well as the MSI install packages produced by the Build MSI Packages Pass #1 1244 process (FIG. 12). The CyberInv.exe 1306 process may also include any other executable software components not directly managed under Visual Studio such as, for example, ocx, *.vbs, *.bat, *.cab, *.js. (in fact, any executable component that is supported by the Software Restriction Policy technology).

The CyberInv.exe process 1306 produces the CyberInv.xls 1307 Excel spreadsheet file 916 shown at FIG. 9, which is examined by an authorized user in the MS Excel program 1310. The CyberInv.xls 1307 file is copied to the folder “Step 4—CyberInv” folder in 1110 in FIG. 11. The binary files having just been compiled are not code-signed; consequently the authenticode field shows an “Untrusted” status for each of the binary components. The friendly name, file type, part number and version (including build number) are extracted directly from the assembly information contained in the source code, therefore truly reflecting the identity of the source code component.

Because the build number is incremented each time the code is recompiled in a Build operation, it is to be noted that the version number will change accordingly. The authorized user eliminates the rows that are irrelevant to the game to be certified and saves the file under the CyberCert.xls 1311 file name which contains the necessary friendly name 512, executable type 514, part number 518 and version 520 information to compose the PKI certificate subject name in accordance with method detailed at FIG. 3 for subsequent code signing. The program path location 510 of the unsigned software components is also available for later retrieval of the unsigned binary file. The CyberCert.xls 1311 file is copied to the folder “Step 5—CyberCert” folder in 1110 in FIG. 11.

The CyberCert.xls 1311 file may be securely copied in encrypted form to a removable media such as a floppy disk, a CD-ROM or a USB disk 1312, or alternatively transferred to another location by secure communication means.

The CyberCert.xls 1311 file is split into 2 files CyberSign1.xls 1317 and CyberSign2.xls 1319. CyberSign2.xls contains only the rows associated to the MSI packages and CyberSign1.xls contains the rows corresponding to the other executable file. CyberSign1.xls is copied to the “Step 6—CyberSign (Pass #1)” folder in 1110 in FIG. 11, and CyberSign2.xls is copied to the “Step 8—CyberSign (Pass #2)” folder.

Step 5 at 1316 includes having a certification authority (CA) 1315 located at the game developers' site or controlled by an authorized trusted party such as VeriSign generating certificates in accordance with the details provided in the CyberCert.xls 1311 file, that is, with a subject name created in accordance with the method detailed relative to FIG. 3. An automated process CyberCert.exe 1318 executing on the off-line CA computer Windows server named CS11 1314 may automate the generation of the PKI public certificates 1326 and the associated private keys 1328 using the CyberCert.xls 1311 file.

The trusted root certificate for the authorized CA 1320 is supplied to the certification lab, the game regulators or other parties for reference and for importing as a trusted root into the ICE computer system and the gaming system certificates store.

The public certificates 1326 and their associated private keys 0.1328 are forwarded to the DEV computer 1332 of the ICE system in encrypted form on a removable media such as a floppy disk, a CD-ROM or a USB disk 1324, or alternatively transferred by secure communication means. Public certificates 1326 and their associated private keys 1328 that are associated with the MSI packages are copied into the “Step 6—CyberSign (Pass #1)” folder in 1110, and the other public certificates 1326 and their associated private keys 1328 that are associated with other software components are copied to the “Step 8—CyberSign (Pass #2)” folder.

Step 6 1336 includes steps of code signing the non-MSI executable components listed in the CyberSign1.xls 1317 file using the corresponding public certificates 1326 and their private keys 1328. The code signing may be performed using the SignCode.exe utility provided by Microsoft, or equivalent. A password may be required for the private key depending on the security option selected when generating the certificate at the CA. The CyberSign.exe process 1330 may automate the code-signing of all the non-MSI executable components listed in the CyberSign1.xls 1317 file using the friendly name, file type, part number and version (including build number) given in each row. The CyberSign.exe process may call the SignCode.exe utility or the equivalent API. During the code signing process, the compiled executable software components may be replaced at 1339 by their code-signed form. Step 6 is designated as “CodeSign Pass#1” 1338.

Step 7 at 1344 includes re-building all the MSI install packages 1345 performed during step 3 at 1242. This time, the MSI packages contain the non-MSI code-signed executable components.

Step 8 at 1340 includes code signing the MSI executable components listed in the CyberSign2.xls 1319 file using the corresponding public certificates 1326 and their private keys 1328. The code signing may be performed using the SignCode.exe utility provided by Microsoft, or equivalent. A password may be required for the private key depending on the security option selected when generating the certificate at the CA. The CyberSign.exe process 1330 may automate the code-signing of all the MSI executable components listed in the CyberSign2.xls 1319 file using the friendly name, file type, part number and version (including build number) given in each row. The CyberSign.exe process may call the SignCode.exe utility or the equivalent API. During the code signing process, the executable MSI software components may be replaced 1341 by their code-signed form. Step 8 is designated as “CodeSign Pass#2” at 1342. The executable MSI software components are copied as shown at 1371 to the CD Pre-Burn repository 1372.

Because of the necessity of performing step 7, the CyberSign 1330 code-signing process to be used for the ICE (Integrated Certification Environment) is designated a “2-Pass code-sign”, as indicated at 1334.

Step 9 1366 includes (a) configuring the software restriction policy (SRP) 1360 for the ICE system test gaming terminals (via the active directory 1350 in the domain controller DC) with the certificate rules corresponding to the certificate produced at step 5 (the *.p7b certificate at reference numeral 1326 may be converted to *.cert certificates for compatibility reasons when configuring the SRP); (b) configuring the Software Installation Policy (SIP) 1368 for the ICE system test gaming terminals with the MSI packages produced at step 7, then (c) using the GPMC (Group Policy Management Console) or equivalent service, exporting the SIP via SIP export scripts 1362 and the SRP via SRP export scripts 1364 (the policy export facility is available in the Group Policy Management Console GPMC 702, 704). These SIP and SRP export scripts may be copied into the folder “Step 9—SIP & SRP” folder in 1110. These SIP and SRP export scripts may be later imported in the gaming operator's 1010 gaming system for enforcing the policies on the game components. SIP export scripts 1362 and SRP export scripts 1364 are stored in the CD Pre-Burn repository 1372 (or into the folder “Step 10—CD Burn—Casino Release” folder in 1110).

Step 10 at 1374 includes steps of burning at 1384 to a CD-ROM 1376 or other removable media the content of the CD Pre-burn repository 1372 comprising (a) the executable MSI software components 1371; (b) the SIP export scripts 5 1362 and SRP export scripts 1364 and (c) other automation scripts in order to automate the installation of (a) and (b). A copy of CD-ROM 1376 may be forwarded (a) to the gaming operator's 1010 gaming system for game deployment (such as a casino 1379), (b) to the certification lab 1378, and (c) a trusted party 1377 such as a lawyer or in escrow for impartial reference in case of later dispute. The CD-ROM 1376 may later be inserted at 1050 in the gaming operator's 1010 gaming system for game deployment.

Step 11 at 1370 includes steps of (a) taking a snap-shot 1387 of the entire development environment for a selected certified game (Visual Studio repository 1302 and Visual Source Safe repository 1214 1218 that contains all the source file, the compiled code-signed executable files and dependant executable files, the non-executable files, project solution, automation scripts, the source and compiled signed code from other development platforms, the media assets from media development platforms such as MacroMedia Director 1228); in (b) taking a snap-shot 1387 of the code-signed MSI installation packages; in (c) optionally encrypting them; and then in (d) copying them into a CD pre-burn repository 1388 (or into the folder “Step 12—CD Burn—VS Snapshot” folder in 1110).

Step 12 at 1386 includes steps of burning at 1382 to a CD-ROM 1380 or other removable media the content of the CD Pre-burn repository 1388 comprising the software components of step 11. A copy of CD-ROM 1380 may be forwarded to the certification lab 1378 and to a trusted party 1377 such as a lawyer or in escrow for impartial reference in case of later dispute.

Steps 4 to step 12 should be carried out each time a source code is being recompiled subsequent to a modification because a unique certificate must be associated to each build. Deviating form this order may jeopardize certificate integrity because of the risk of a human error that may result in the wrong certificate being used during the code signing process.

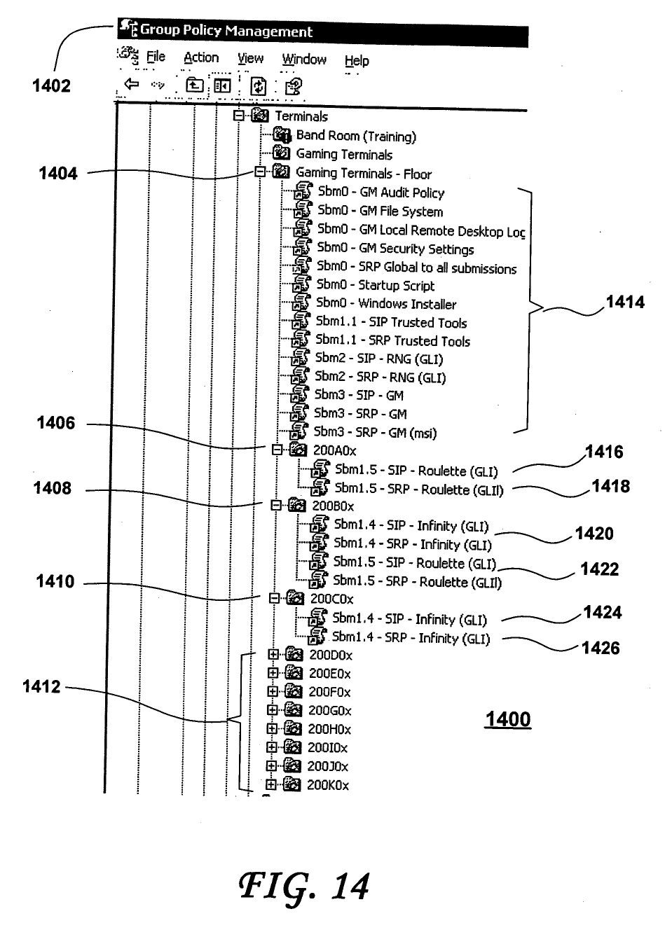

FIG. 14 illustrates assignment of policies by banks of gaming machines. Reference numeral 1400 in FIG. 14 shows the grouping of gaming terminal and the associated enforced policies. In this illustration, the Group Policy Management console 1402 may be configured such that the active directory Organization Unit (OU) named “Gaming Terminals—Floor” at 1404 is architectured to regroup the gaming terminals in “banks” or sub-Organization Units (sub-OUs) identified by 200A0x 1406, 200B0x 1408, 200C0x 1410, and 200D0x to 200K0x at reference numeral 1412. Each bank contains a predetermined number of gaming terminals, in multiples of 8 units, for example.

Noting the hierarchical tree composed of the OUs and sub-OUs illustrated at 1400, all the policies 1414 apply to the OU “Gaming Terminals—Floor” 1414 which contains all the sub-OUs 1406 1408 1410 and 1412. Using this technique, all the policies 1414 may apply to all the 3000 gaming terminals of a large casino. In the same manner, the policies 1416, 1418 apply to the bank 1406; the policies 1420, 1422 apply to the bank 1408; and the policies 1424, 1426 apply to the bank 1410.

In the illustration, the exemplary game named “Roulette” is assigned a policy named “Sbm1.5—SIP—Roulette (GLI)” 1416 which configures the Software Installation Policy (SIP) and a policy named “Sbm1.5—SRP—Roulette (GLI)” 1418 which configures the Software Restriction Policy (SRP) for that game.

In the same manner, the exemplary game named “Infinity” is assigned a policy named “Sbm1.4—SRP—Infinity (GLI)” 1424 which configures the Software Installation Policy (SIP) and a policy named “Sbm1.4—SRP—Infinity (GLI)” 1426 which configures the Software Restriction Policy (SRP) for that game.

The keyword “Sbm1.4”, in this example, denotes the certification submission number 1.4, and the keyword “GLI” denotes the certification lab GLI (Game Laboratories International) approving the Infinity game software.

In the illustration, all of the game terminals regrouped in the bank 200A0x shown at 1406 are, therefore, configured to execute the Roulette game, all the game terminals in the bank 200B0x shown at 1408 are configured to execute the Roulette game and the Infinity game, and all the game terminals in the bank 200C0x shown at 1410 are configured to execute the Infinity game.

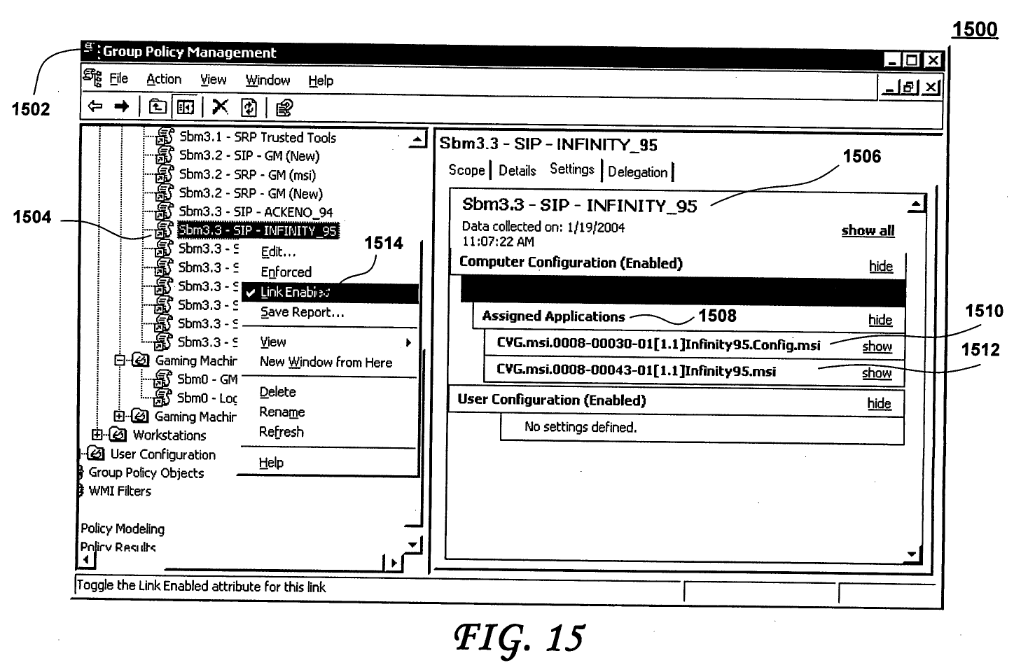

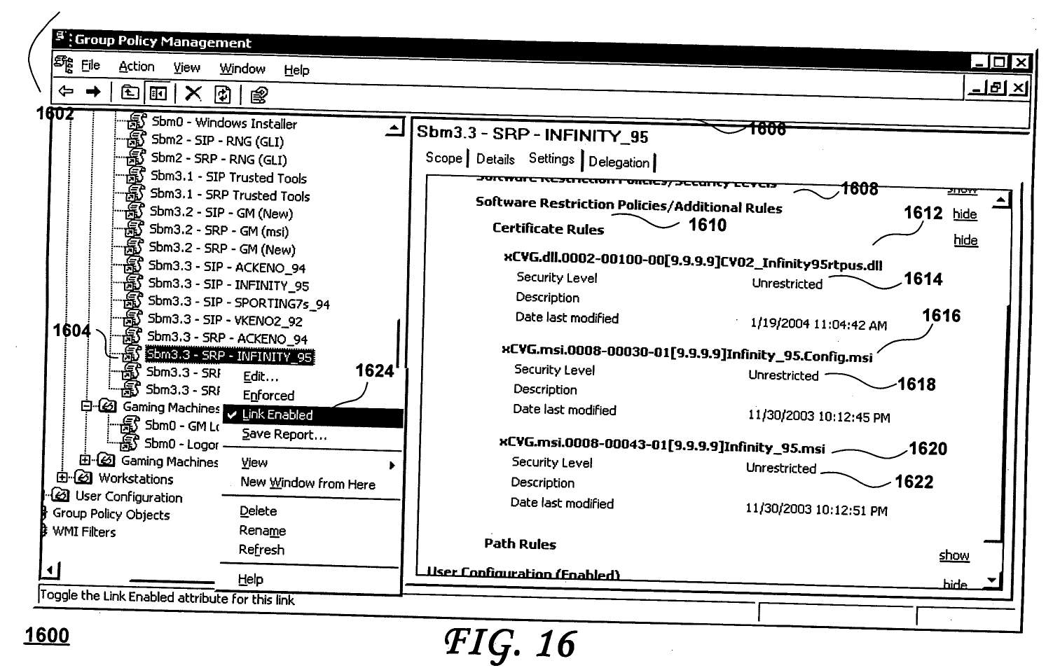

FIG. 15 shows the enforcement of a Software Installation Policy (SIP). In FIG. 14, banks of gaming terminals are configured to execute authorized games using SIPs and SRPs policies. However, in order for the gaming terminals to be able to install a game, the associated Software Installation Policy must be enforced. At 1500, FIG. 15 illustrates a method for enforcing a Software Installation Policy by “linking” the policy, according to an embodiment of the present invention. This is accomplished in the Group Policy Management console 1502 by, e.g., right-clicking the selected policy 1504, 1506 “Sbm3.3—SIP—INFINITY_{—}95” associated to the Infinity game with a Return To Players (RTP) percentage of 95% and selecting the “link Enabled” attribute 1514. The software components for the Infinity_{—}95 game contained in the two MSI installation packages 1510 and 1512 will subsequently be installed, provided the associated SRPs are configured to authorize execution of these two MSI packages (refer to description for FIG. 16). Alternatively, the same procedure may be automated via an API called from an appropriate application. It is to be noted that the linking of the policy will in fact enable the enforcement of the policy, but the policy will only be enforced on the gaming terminal when a gpupdate command or equivalent command is performed at the terminal; a terminal reboot may also be required for the policy to be enforced. Also to be noted is that policy changes are automatically distributed by the Windows server operating system throughout the network connected gaming system at periodic intervals; this automatic process may preferably be disabled such as to obtain more predictable policy enforcement changes by issuing explicit commands instead.

Package 1512 (friendly name: Infinity95.msi) contains the executable software components for the Infinity game and package 1510 (friendly name: Infinity95.Config.msi) contains the configuration files (the non-executable files) for the Infinity game. Package Infinity95.Config.msi 1510 is re-installed in the process 938.

FIG. 16 illustrates the enforcement of a Software Restriction Policy (SRP). In FIG. 14, banks of gaming terminals are configured to execute authorized games using SIPs and SRPs policies. However, in order for the gaming terminals to be able to execute the games, the policies must be enforced. FIG. 16 at 1600 illustrates a method for enforcing a Software Restriction Policy 1608 by “linking” the policy. This is accomplished in the Group Policy Management console 1602 by, e.g., right-clicking the selected policy 1604, 1606 “Sbm3.3—SRP—INFINITY_{—}95” associated to the Infinity game with a Return To Players percentage (RTP) of 95% and selecting the “link Enabled” attribute 1624.

The certificate rules 1610, 1616 and 1620 that are configured with the “Unrestricted” attribute 1618, 1622 authorize the installation of the software components for the Infinity_{—}95 game contained in the two MSI installation packages 1510 and 1512 by authorizing the unique PKI certificate associated to those MSI produced in accordance with the present method. The “.dll” executable software component 1612 is authorized, has its security level attribute set to “Unrestricted” and is, therefore, authorized to execute once it is installed.

The two MSI installation packages 1510 and 1512 for installing the software components for the Infinity 95 game have their associated unique PKI certificate 1616 and 1620 (produced in accordance with the method described herein) configured with the “Unrestricted” security level attribute 1618, 1622 via the certificate rules 1610, thus enabling (or authorizing) execution and installation of the software components for the Infinity_{—}95 game.

The “.dll” executable software component contained in the 1512 package has its security level attribute set to “Unrestricted” thus it is authorized to execute once it is installed.

Alternatively, the same procedure may be automated via an API called from an appropriate application. It is to be noted that the linking of the policy will in fact enable the enforcement of the policy, but the policy will only be enforced on the gaming terminal when a gpupdate command or equivalent command is performed at the terminal; a terminal reboot may also be required for the policy to be enforced. Also to be noted is that policy changes are automatically distributed by the Windows server operating system throughout the network connected gaming system at periodic intervals; this automatic process may preferably be disabled such as to obtain more predictable policy enforcement changes by issuing explicit commands instead.

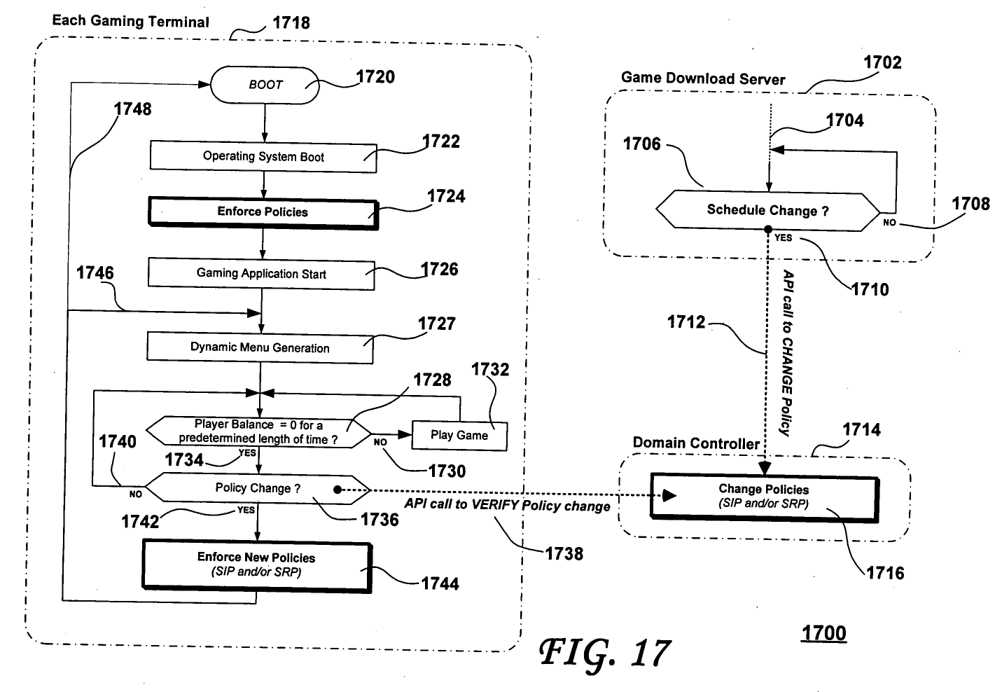

FIG. 17 illustrates a method at 1700 to enforce a policy at a predetermined time, according to an embodiment of the present invention.

Enabling enforcement of policies as described relative to FIG. 15 and FIG. 16 may be carried out interactively by an authorized user at predetermined authorized times, or alternatively may be controlled by a process at predetermined authorized times via the appropriate API. At the central system 1702 (the game download server in this illustration) at a given time 1704, a user or a process may verify a change 1706 in the list of games to be made available to players on a selected set of gaming terminal banks. In case of a schedule change as shown at 1710 (or other reasons such as introducing a new game or revoking an existing game), policies on the domain controller 1714 are being changed accordingly either interactively by a user in the Group Policy Management console as described for FIG. 15 and FIG. 16, or by a process via the equivalent APIs 1712. The changed policies are being enabled for enforcement at 1716 in the domain controller.

In a casino, although new games may be scheduled to be downloaded to gaming terminals and activated at predetermined times, it is a requirement that games are not to be changed while a player is playing. In practical terms, it is considered that a player terminates playing when his or her credit balance remains at zero for a predetermined period of time. The predetermined period time should be sufficient to allow the player to enter a new bill or other form of credit or payment instrument to continue playing. Therefore, the game application software on each game terminal continually tests for this condition (credit=0 for a predetermined period of time) before checking for change in policy, enforcing the policy changes and then updating the menu of games to be made available to the next player.

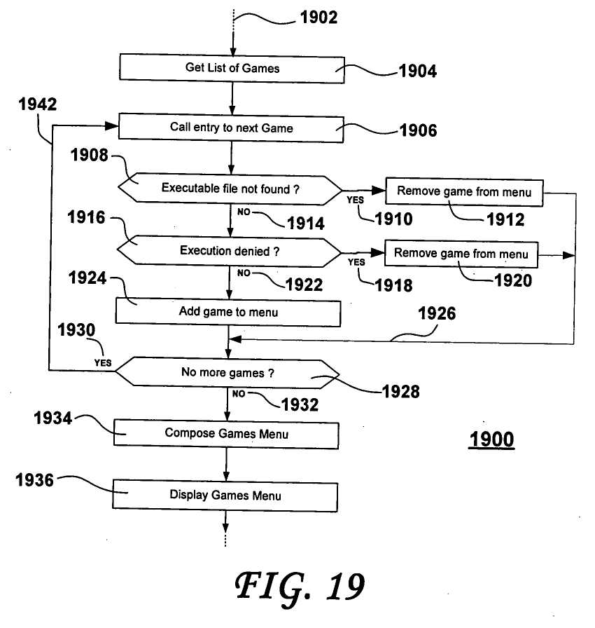

Upon power-up, each gaming terminal 1718 executes a boot 1720, loads its operating system 1722 and enforces the policies 1724 that are configured at the time of the start-up process. When the game application starts at 1726, it displays a menu of authorized activated games as shown at 1727 to the player using for example the dynamic method described relative to FIG. 19. Whenever the player balance is non-zero 1728, 1730, the player may play as shown at 1732 the games listed on the menu in accordance with the enforced policies. When the player's balance reaches zero at 1734 and remains zero for a predetermined period of time, it is considered that the player is no longer playing. The gaming application of the gaming terminal may then verify at 1736 if a policy has changed 1738. This may be done via the RegisterGPNotification. The RegisterGPNotification function enables an application to receive notification when there is a change in policy. When a policy change occurs, the specified event object is set to the signaled state. Additional details regarding the RegisterGPNotification function may be found at http://msdn.microsoft.com/library/default.asp?url=/library/en-us/policy/policy/registergpnotification.asp.

At 1740, if there is no change in policy, the games listed on the menu will be unchanged for the next player. If there is a change in policy at 1742, the gaming terminal may enter into a process whereby the policies are enforced as shown at 1744, using for example the gpupdate.com service, the RefreshPolicy function or the RefreshPolicyEx function, or equivalent services or API. It is to be noted that the verification of change in policy and the enforcement of the changed policies may be carried out by each terminal independently.

The RefreshPolicy function causes policy to be applied immediately on the client computer. Additional details regarding the RefreshPolicy function may be found at http://msdn.microsoft.com/library/default.asp?url=/library/en-us/policy/policy/refreshpolicy.asp

The RefreshPolicyEx function causes policy to be applied immediately on the computer. The extended function allows specifying the type of policy refresh to apply. Additional details regarding the RefreshPolicyEx function may be found at http://msdn.microsoft.com/library/default.asp?url=/library/en-us/policy/policy/refreshpolicyex.asp

Once the change in policy is enforced at 1744, the gaming terminal may reboot as shown at 1748 or exit and re-enter the gaming application, Which would dynamically recreate the menu list of games 1727 to be made available to the next player, as detailed at FIG. 19.

A similar method relying on explicit WMI calls and administrative templates (*.adm) may be applied to obtain the same result in gaming environments whereby the domain controller active directory is not available such is the case with gaming terminals connected in WAN (Wide Area Network) whereby the network bandwidth is limited or the network availability is poor.

An alternative method relying on SMS (System Management Server) code download instead of SIPs (Software Installation Policy) for installing software components and software MSI packages may be used. However, the executable software components remains under SRP (Software Restriction Policy) in accordance with the unique PKI certificate generated for each component as described in the invention.

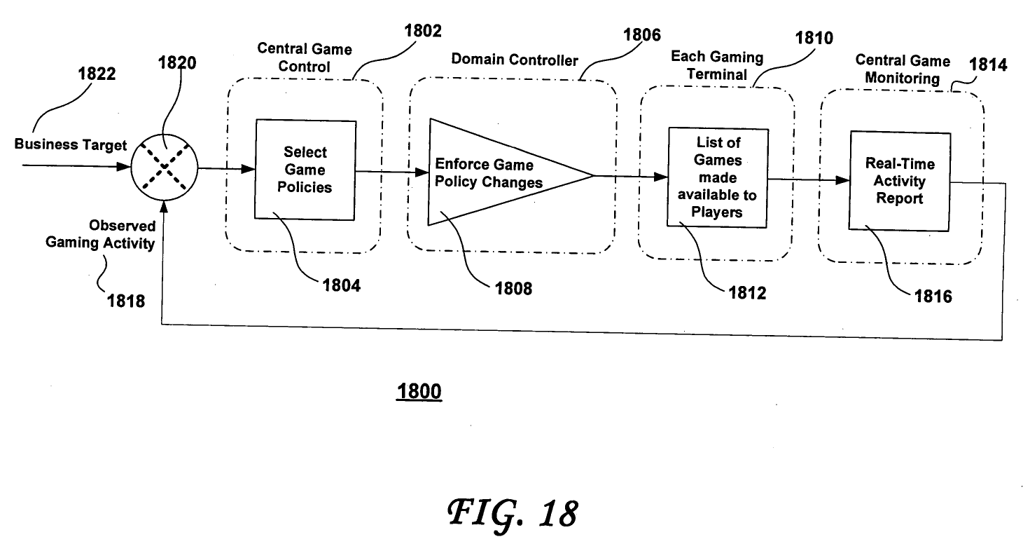

FIG. 18 shows a close-loop enforcement of a policy, according to an embodiment of the present invention. FIG. 18 at 1800 illustrates a method to enforce a selected policy as the result of observing the gaming activity. The method is directly derived from FIG. 17 whereby the policy change 1716 takes place at 1804 and is selected from a choice of pre-configured policies, for example in a look-up manner, whereby a policy would result in making available to the players a menu of games 1812 (1727 in FIG. 17) to provoke a given gaming activity change which may be monitored in real-time at 1816. The observed activity 1818 may then be compared 1820 to predetermined businesses objectives 1822 and a correction or modification may be applied by selecting a new policy that would change the list of games available on a selected aggregate of gaming terminals 1810. For example, due to a long queue of people who want to play the Infinity game, a greater number of banks of gaming terminals may be configured to make the Infinity game available to players on these terminals. Another reason for applying a new policy might be if a particular area of the casino floor is heavily populated with players while another area is empty. Suppressing some popular games in a highly frequented area and adding them to the less frequently area may help spread the player distribution within the casino or gaming area more evenly. Yet another reason for applying a new policy could be if the gaming activity is low, then games with a higher RTP (return to player), let us say 98% instead of 95%, may be activated in some areas to boost activity.

The process may involve several subsystems as illustrated in FIG. 18: the central game control 1802 wherein policies are selected, the domain controller 1806 that enables enforcement of the policies 1808, a selection set of gaming terminals 1810 wherein each gaming terminal enforces the policies and make the selected games available to the player 1812, a central game monitoring system 1814 that produces activity reports in real time 1816.

The process shown at 1820 of comparing the observed activity 1818 and the targeted activity 1822 and then selecting a change in game policies 1804 may be carried out by the floor manager or the floor director, or alternatively by a knowledge base process. In both cases, a close-loop enforcement of policies (relying on the unique PKI certificate SRP associated to each executable authorized and certified software component) is achieved resulting in the dynamic configuration of the gaming system, either for LAN configurations (such as casino floors) or WAN configuration (such as video lottery terminals distributed across a large geographic area).

FIG. 19 at 1900 illustrates a method to generate dynamically the menu list of authorized games made available to the player on each gaming terminal, according to an embodiment of the present invention. The dynamic configuration of a large gaming system whereby authorized games made available to players on selected group of gaming terminals using software restrictions policies at the central system may result is hundreds of different game menus. Reliance on SRPs for preventing non-authorized software components to execute is entirely based on a sound and demonstrable trusted base; therefore the gaming system is trusted. Getting the list of authorized games to each gaming terminal would require configurations files to be sent from the central system to each of the gaming terminal; however, this would be illegal because the change in the list of games may affect the game outcome. This is clearly understandable when considering changing a game; let us say Infinity_{—}95 with a RTP or 95% with Infinity_{—}98 with a RTP of 98% at 10:00 PM, then back at 8:00 AM, and this each day except during the weekend, or at other times as a result of the closed loop process described at FIG. 18. Game regulators mandate that the process to manage this type of change be certified with secure means of the same order as when installing/downloading software components using a unique PKI method.

Embodiments of the present invention, therefore, provide secure means to update a list of authorized games to be offered to the player. The menu of authorized games offered to the player may be dynamically generated by each terminal without requiring the central system to dispatch the list of authorized games or having each terminal fetch the list of authorized games from the central system (both are illegal without extreme precaution of the same order as the installing/downloading of software components using a unique PKI method because they may affect the game outcome); this is achieved by having each terminal checking the certificate Software Restriction Policies enforced on the games (a unique PKI certificate being generated for each of the executable game components in accordance with the methods detailed in this document).

As illustrated in FIG. 19 at 1900, each terminal when executing the gaming application 1902 gets a list of the file names for the games available at 1904 from a trusted configuration file (an updated trusted configuration file may have been downloaded in a certified code signed MSI package with the last game download) and a menu is initially compiled for this list. Attempts to execute each of the game entry module of the games contained in the list 1906 are made. If the game entry module is not found at 1910, the software components do not exist on the gaming terminal and the game is removed from the menu 1912, whereupon the process iterates to next game, as suggested at 1926 1928. If the execution of the game entry module is denied at 1916, 1918 because the Software Restriction Policy is preventing this game to execute, the game is removed from the menu as shown at 1920 and the process iterates to next game, as shown at 1926 1928. If the execution of the game entry module is successful at 1922, then the game is authorized and may be added to the games menu offered to the player. The process iterates through other games in the list, as shown at 1928, 1930, 1942, 1906, if any. Once the iteration is completed at 1932, the games menu may be composed at 1934 and the menu is displayed to the player at 1936.

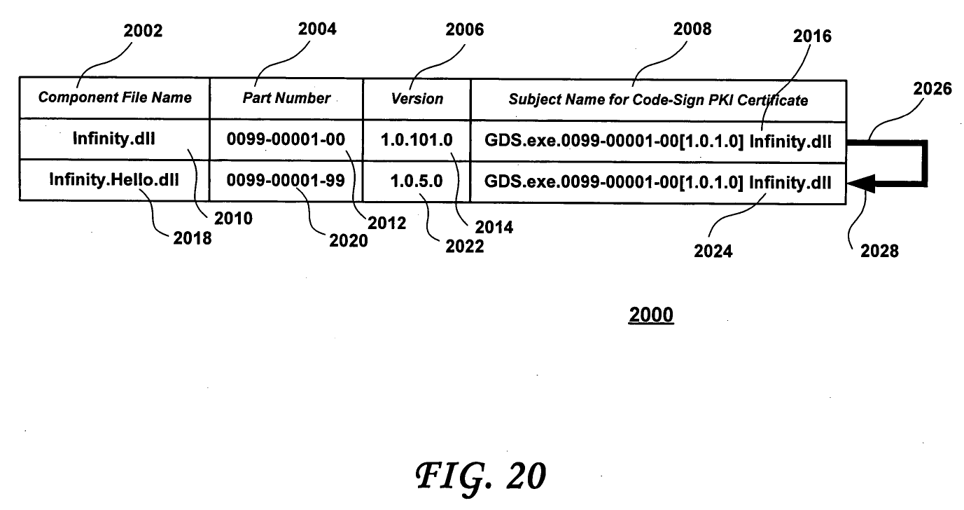

FIG. 20 shows a companion Hello component, according to another aspect of the present invention. Reference numeral 2000 in FIG. 20 illustrates a method to generate a code signed companion software component. Each game comprises an aggregate of executable and non-executable software components, usually comprising files such as *.exe, *.dll, *.dat, *.xml. In general, all the software components are dependent of one component named the main program or the game entry. Starting the execution of the main game component is a lengthy process, as a large number of dependent executable components and graphics need to be verified (SRP verification) and started. Currently, there is no API available in the Windows operating system client computer for verifying the status of a Software Restriction Policy enforcement on a given software component applicable to that client computer.

Another embodiment of the present invention, therefore, provides a method to quickly verify the policy enforcement on a game without starting the entire game, in order to generate the list of available games to be made available to the player in a menu. For each game, a very short companion .dll file may be created having, for example, only one line of code <<Return “HELLO”>> which would return the exemplary “HELLO” string when called. Assuming “Infinity.dll” 2010 is the main game component file name 2002 (or friendly name), then the companion file may be named “Infinity.Hello.dll” 2018. Preferably, the companion's 2018 source code would have in its assembly information a part number 2004 as shown at 2020 and a version number 2006 as shown at 2022 that is identical to the main component 2010 part number 2012 and a version number 2014, but this is not mandatory. In addition, assuming the PKI certificate's subject name 2008 associated to the Infinity.dll is “GDS.exe.0099-0001-00[1.0.101.0] Infinity.dll” 2016, which is used for the code signing of the Infinity.dll, we may proceed with the code signing of Infinity.Hello.dll with the same 2026, 2028 “GDS.exe.0099-0001-00[1.0.101.0] Infinity.dll” certificate, as shown at 2024.

It is to be noted that code signing two distinct software executables with the same certificate is a deviation from the method taught earlier in this document. However, the fact that the role of the companion file is very well defined, as having for example only one line of code <<Return “HELLO”>> which would return the “HELLO” string when called, this does not present an issue with the regulators or the certification lab.

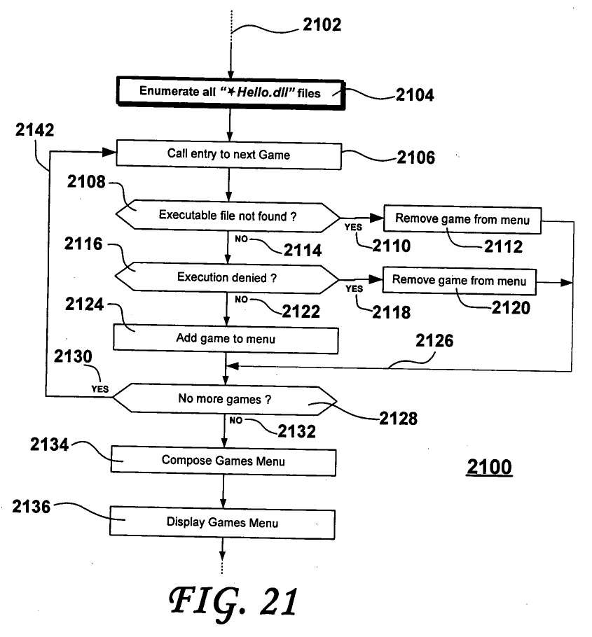

FIG. 21 shows steps that may be carried out to search for games on each gaming terminal, according to yet another embodiment of the present invention. Reference numeral 2100 in FIG. 21 illustrates a method to quickly generate dynamically the list of games installed on each gaming terminal using the companion software component described above. The process of dynamically generating the game selection menu may be optimized in many ways in order to reduce the overhead of starting the execution of a game to check if it is authorized. However, if the aim is to sense for the enforced SRP or SIP applied to the game or detect local availability of the game software components, then such optimizations (among other possible variations) should be considered to be within the scope of the invention as defined by the claims hereunder. According to an embodiment of the present invention, a method is presented herewith to quickly generate the list of available games to be made available to the player in a menu without transfer of a file from the server. Reference 2100 is identical to reference 1900 in FIG. 19 except for the first process 2104 whereby a file search process is performed for finding (or enumerating) file names with the “*Hello.dll” string, the “*” symbol being the standard wild character used in string searches. A list of the games installed on each gaming terminal may be quickly and dynamically generated by calling the companion software component of the game main component instead of calling the main component itself. The companion component may be as detailed at FIG. 20 or may be a similar construct.

The embodiments of the present invention described herein are also applicable to any of the subsystems available in a network connected gaming system that require preventing non-authorized software components to execute or affect game outcome, such as the gaming terminals, the game management system (CMS or MCS) that monitor and control whole or part of the estate of gaming machines, the progressive jackpot systems, the bonussing systems as well as game payment verification systems such as IGT EasyPay and Cyberview PVU (Payment Verification Unit) and PVS (Payment Verification System). Gaming subsystems are tested against gaming standards such as those produced by GLI (Game Laboratory International); the game standards are mandated by game regulators in accordance with local regulation and laws. The network-connected subsystems may be located within the premises accommodating the estate of gaming machines (connection via a LAN) or outside of the premises (connection via a WAN).

The methods described in the document rely on software installation policies and Software Restriction Policies which may be configured (a) via the domain controller active directory, as this is advantageously the case whenever the network connection is a LAN, and which may also be configured (b) to each of the local computers via WMI services (Windows Management Instrumentation) or administrative templates (.adm files) in order to configure and enforce local group policies when a domain controller is not available as this is the case whenever the network connection is a WAN. Microsoft SMS (Systems Management Server) may be used as an alternative to using software installation policies.

The methods described in the document leverage on software installation policies and/or software restriction policies technology implemented in Microsoft Windows operating system. Whenever similar technology is implemented in other operating systems such as Linux, Unix, Windows CE and QNX, it is considered as part of the invention herein.

In an other embodiment of the invention, it order to make game regulators more at ease with the huge shift in paradigm from prehensile physically secured ROM based gaming machines (whereby access to the ROM is via multiple layers of keys locks and tamper detectors), to a totally virtual or volatile fashion of downloading game code via a network, it may be advantageous to perform download of the game code when the gaming machine is not operational. Consequently, the network downloading of game code from a central repository may not interfere with the games. This may be accomplished by terminating all gaming software in order to transform the gaming machine into a generic PC, then transferring the game software under the control of the operating system using pervasive network code download available in most information technology networked environments. An “Out-of-service” message may be displayed on the screen to indicate that the machine is no longer playable, thus is no longer a gaming machine. Once the game code is downloaded by the generic PC, the game code is verified for trustworthiness and is executed, thus transforming the generic PC back into a gaming machine.

According to further embodiment of the present invention, gaming machines may be configured to change operation and/or appearance depending upon any one or a combination of characteristics. In this manner a casino may configure one, selected ones or all of its gaming machines change from an initial state of operation and/or appearance to a changed mode of operation and/or appearance and to return to the initial or some other state at some later point in time. According to further embodiments, many gaming machines within a given location may be caused to alter their mode of operation and/or appearance so as to individually or collectively create a theme that is pleasing to a given population of patrons. According to embodiments of the present invention, a theme is a unifying idea, image, color scheme or style that is a recurrent element in the appearance, visual or aural aspect or operation of the games played on the gaming machines, collectively giving the themed gaming machines an impression of unity or giving an individual themed gaming machine a central and perceptible character. Alternatively, a theme may be described as being composed of selected ones of a plurality of authorized games. In that case, the selection of a theme or of a combination of themes may include a step of filtering out selected games from a pool of games that have been authorized by the relevant gaming jurisdiction. Such a selection step, therefore, does not involve any regulatory issues and may be executed by anyone, without prior regulatory approval.

According to embodiments of the present invention, themes may incorporate predetermined games, modes of operation, predetermined music and/or sound effects and predetermined color combinations, graphics and video clips, to name but a few possibilities. The theme developed may be caused to persist for as long as desired or for as long as a given population of patrons is present in the casino or other gaming establishment. This may be done to make the gaming machines appear more desirable to a given population of patrons (or players, as the two terms are used interchangeably herein), as determined by, for example, marketing intelligence, demographic data, time of day, cultural mores and the like. For example, embodiments of the present invention enable individual gaming machines, selected gaming machines or all of the gaming machines in a casino to be dynamically themed according to characteristics such as culture, age, political affiliation, hobbies, ethnicity, and religious affiliation (to name but a few possible characteristics) that may individually or in combination affect a patron's decision to play or to remain playing a certain gaming machine or a predetermined set of gaming machines.

The ability to develop and to dynamically implement such themes at any time and for any duration on the casino floor is believed to be a powerful tool to increase receipts from the themed gaming machines. For example, should a casino manager know in advance that a large group of racing car fans is due in the casino at a given time, some or all of the gaming machines in the casino may be dynamically configured to change their mode of operation and/or appearance to better suit the perceived tastes of race car fans. Such might include configuring some or all of the gaming machines to include racing imagery, sounds, paid endorsements by famous race car drivers, and the like. Moreover, marketing intelligence may have uncovered that a majority of racing fans respond positively to country music (for example) and various positive representations of national identity. Such marketing intelligence may be garnered, for example, casino loyalty programs and/or from the advertising sector, which carefully tailors its televised advertisements to their target audience during say, televised NASCAR® events. Therefore, the theme developed and implemented on the casino floor may incorporate recommendations gleaned from analysis of such marketing intelligence and incorporate specific color combinations, graphics, music and video during game play on the themed gaming machines. When the racing fans leave the casino, the themed gaming machines may then be returned to their initial state or to some other state and assume a different mode of operation and/or appearance. For example, the gaming machines may then be configured to appeal to older Asian patrons by incorporating different imagery, color combinations and music.

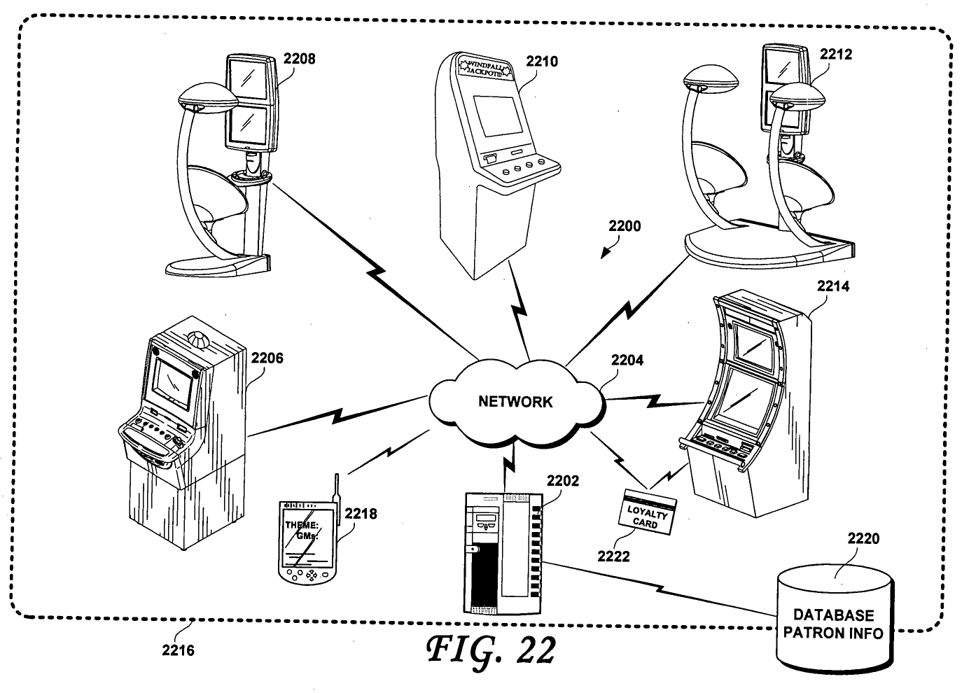

FIG. 22 shows an exemplary estate of gaming machines 2200 on which embodiments of the present invention may be practiced. FIG. 22 shows a network 2204, which may be a wired or wireless secured network. A server 2202 may be coupled to the network 2204, as may be a variety of gaming machines, such as designated by reference numerals 2206, 2208, 2210, 2212 and 2214. In real world applications, many more gaming machines may be coupled to the network 2204. Such gaming machines 2206, 2208, 2210, 2212 and 2214 may be of the cashless type and/or may accept various forms of money, electronic or otherwise. The estate of gaming machines 2200 may be controlled by the server 2202 (Central Outcome Determination—COD), in that the server 2202 may determine the outcome of the games played on the gaming machines. Alternatively, the outcome of the games may be determined locally (Local Outcome Determination—LOD), at each of the gaming machines. The server 2202 may be wholly absent, or may be relegated to keeping track of which gaming machines store the players' meters, or for some other auditing or business-related purpose not related to game play. Indeed, the network of gaming machines may operate entirely without a central server, in a peer-to-peer fashion. According to embodiments of the present invention, one or more of the gaming machines 2206, 2208, 2210, 2212 and 2214 may be configured so as to collectively create a theme or themes. The choice of implementing a given theme may be controlled by the manager of the casino 2216 and/or programmatically, from the server 2202. Alternatively still, individual patrons may configure their gaming machines to adopt a given mode of operation and/or theme, through interaction with the gaming machine's user interface.

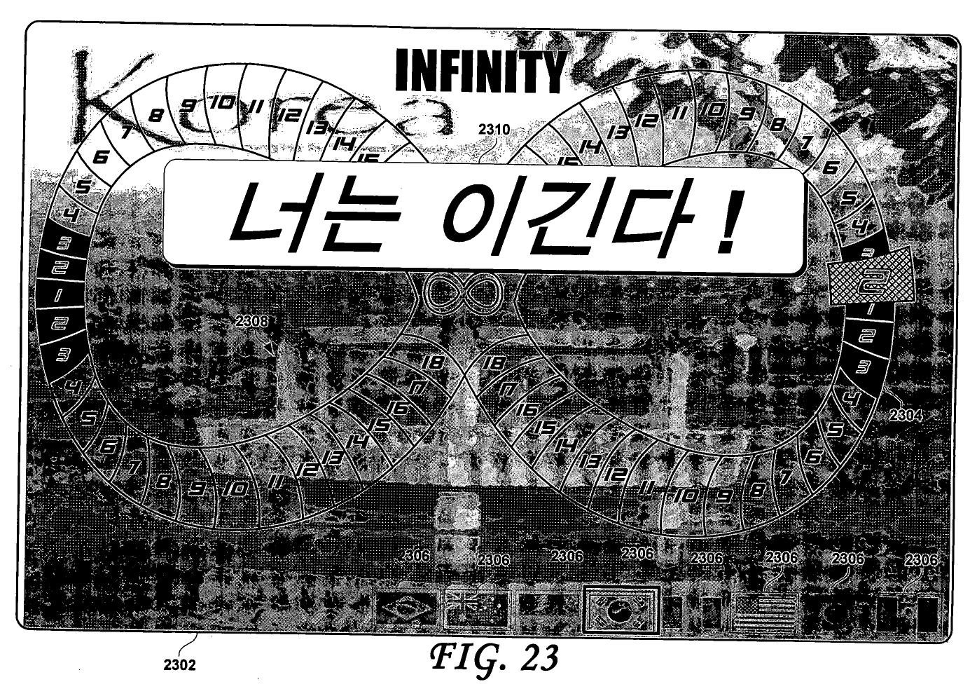

FIG. 23 shows an example of a display 2302 of a themed game on a gaming machine. According to the embodiment shown in FIG. 23, the display 2302 displays a game 2304 and a plurality of individually selectable icons 2306. In this embodiment, the icons include representations of national flags, although any other images may be used, according to the themes available. For example, the patron may be given the opportunity to select one of the icons according to his or her pleasure. In the example shown in FIG. 23, the patron has selected the flag of the Republic of Korea. Accordingly, the icon including the flag of South Korea may be highlighted and the other icons may be subdued rendered transparent to some degree. Following the patron's selection of the icon 2306 including the flag of Korea, the gaming machine may, for example, select a number of games that may be familiar to the patron and/or alter the appearance and/or operation or sound of the games available to the patron. In the embodiment illustrated in FIG. 23, selecting the Korea icon 2306 has caused the gaming machine to display a culturally significant or representative scene of the ROK and/or render all or some of the messages in the Korean language, such as “□□ □□□!” for the message “You Win!”. Korean pop music may be played by the gaming machine and the color scheme of the game may be adapted so as to induce lucky and happy feelings in the player, for example. Rather than national origin, the icons 2306 may be configured to suggest various hobbies, faiths, ethnicity, political or any other affiliation.

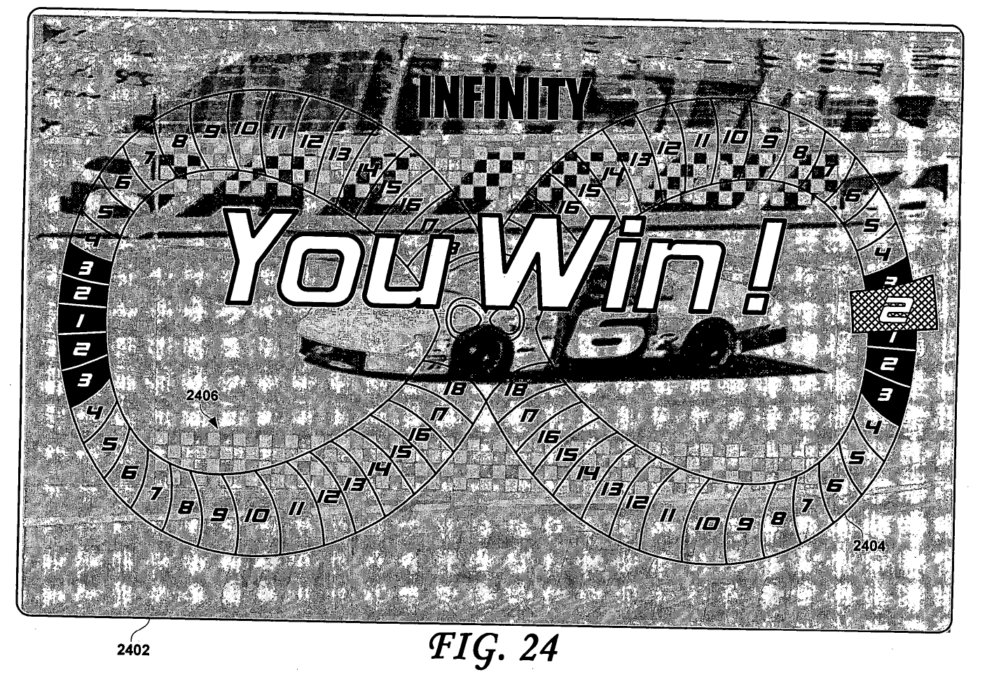

According to another embodiment of the present inventions, the gaming machines may not give the patron the ability to change the appearance of the gaming machines. Instead, such changes may be made remotely, either programmatically or by the casino manager. FIG. 24 shows another example of the present embodiments, in which the patron is not given the opportunity to select or alter the theme of the gaming machines. In this case, the theme is automobile racing, as shown on the display 2402. The racing theme may include, for example, a background image or video suggestive of racing as shown at 2406 against which the game 2404 may be played. Additionally, the gaming machine may be configured to play race track sounds, such as, for example, cheering crowds, screaming engines and screeching tires to heighten the player's excitement during game play. Such a racing theme may be implemented on selected ones or all of the gaming machines 2206, 2208, 2210, 2212 and 2214 within the casino 2202. Such a theme may be selected by the casino management or may be programmatically driven by a central server 2202, for example.

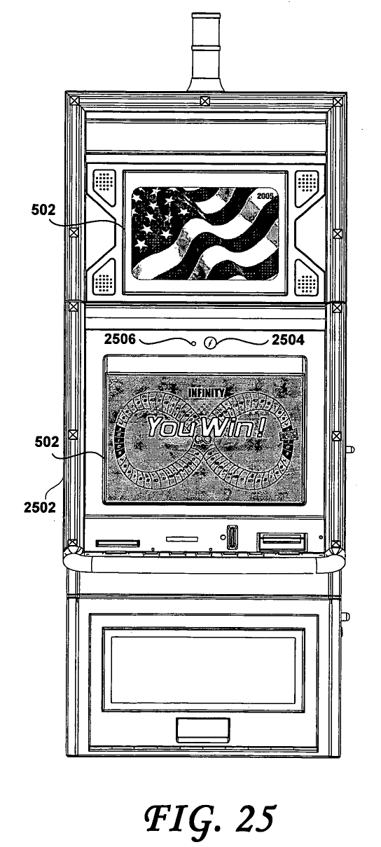

FIG. 25 shows another embodiment of the present invention, in which a dual display gaming machine 2502 uses both displays to implement the chosen theme. As shown, the gaming machine 2502 may enable game play on one display 2504, the game play on the display 2504 being themed in a manner similar to that shown in FIG. 24. Also as shown, the gaming machine 2502 may display complementary images and/or video clips, information or a TV channel or channels on its second display 2506. In this case, a representation of the United States flag is shown in the second display 2506. However, any images and/or video clips may be shown on the second display 2506 that assist in creating the desired theme. For example, the second displays of a plurality of co-located gaming machines may show the same images and/or video clips. Such images and/or video clips may be synchronized across the plurality of gaming machines so as to reinforce the desired theme. Alternatively, the second displays may be electronically linked together so as to form a larger, composite display evocative of the chosen theme. Many other possibilities variations may be implemented within the context of the present inventions.

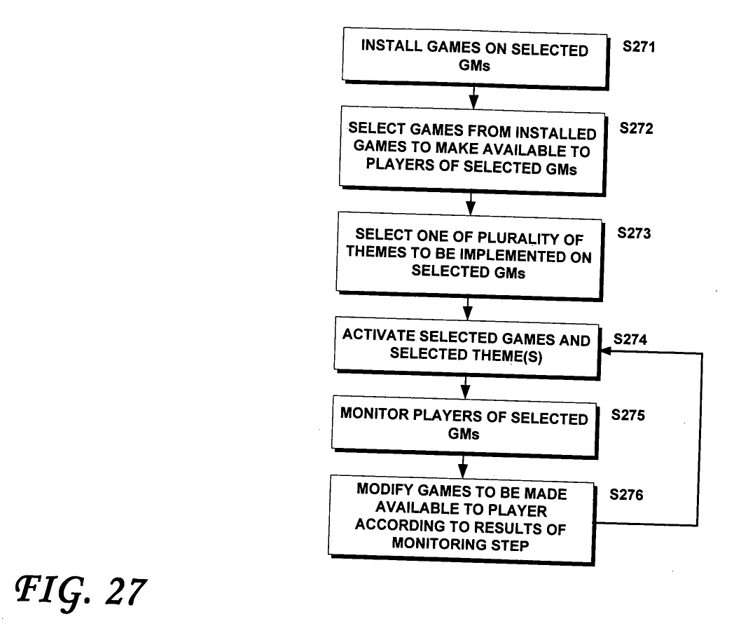

For example, a theme may be developed and implemented across selected gaming machines to promote a special event for a predetermined target audience. Although a selected plurality of gaming machines may be especially themed, the gaming machines may still offer the patron the ability to change the implemented theme on his or her gaming machine by, for example, selecting an icon as shown in FIG. 23. Alternatively, the themed gaming machines may not allow such functionality, so as to maintain the integrity of the implemented theme. Different games may be offered to the player, depending upon the theme chosen by the patron or imposed upon the gaming machine, and these combinations of games may collectively form a theme. For example, some games and/or color combinations are more popular with Chinese patrons and these may be offered instead of or in addition to other games and/or color combinations. For example, the menu of games offered to the player may be dynamically changed depending upon the theme. Within that context, the menu of authorized games offered to the patron may be dynamically generated by each gaming machine without requiring a central system to dispatch the list of authorized games or having each gaming machine fetch the list of authorized games from a central system; this may be done by having each terminal check the policies enforced on the games. Indeed, a process may be implemented in each gaming machine to attempt to execute each of the entry point for each game (the parent module which is first called upon selecting a game to play). If the execution succeeds, then the game is authorized and may be added to the games menu offered to the player. If the execution is denied (SRP is unlinked or the security level is disallowed), then the game is not authorized and may be removed from the games menu offered to the player. Similarly, if a game entry software component file is not found, then the software is not installed or has been removed and is removed from the games menu offered to the player. The process of dynamically generating the game selection menu may be optimized in many ways to implement various themes. The themes and the games available to the patrons may be changed in a closed-loop fashion such as to optimize player game activity in real-time. That is, the makeup of the patron population may be monitored in real time and adjustments to the available games and/or implemented theme may be made on the fly, depending upon the results of the monitoring of the patrons. Such an embodiment is shown in FIG. 27. As shown therein, step S271 calls for installing a plurality of game software components on selected ones of a plurality of gaming machines (such as the gaming machines shown in FIG. 22). All or selected ones of the installed games may then be made available to the patron on the selected gaming machines, as shown at S272. In addition to the selected games, step S273 calls for one or more selected themes may be implemented on the selected gaming machines. Each of the plurality of predetermined themes may include a predetermined combination of game files. The game files may include media files, such as movies, sounds, graphics and the like. For example, the selected theme may be integrated into one or more of the selected games or the selected theme may be external and independent of the selected games (e.g., the selected theme may appear in a second display screen of the gaming machine). The selected games may then be made available to the patron in a (hierarchically arranged, for example) menu of available and authorized games. The selected game(s) and selected theme(s) may then be activated, and the patron may then play any of the activated games. Step S275 calls for the patron to be monitored while he or she is playing the selected games (or even standing near one of the gaming machines, for example). For example, one or more above-listed characteristics of the patron may be monitored during game play. The games available to the patron may then be modified depending upon the results of the monitoring step, as called for by step S276. For example, the hierarchical menu of available games may be changed depending upon the monitored patron characteristics. The method may then revert back to step S271 or S272 such that the games made available to the patron match his or her characteristics that were monitored at step S276. If new games need to be installed on the patron's gaming machine, step S271 may be carried out. If necessary, new games may be downloaded to the patron's gaming machine to carry out the installation step of S271. If all needed games to be made available to the patron have already been installed, the method may revert back to step S272, to select from the installed games those that will be made available to the patron, based upon the results of the monitoring step at S276. In this manner, the depicted steps may be executed in a close-loop fashion to optimize both player game activity and revenue in real-time.

According to further embodiments, a selected theme may be implemented during game play, or may be rendered only when a player is not currently playing on the themed gaming machine. In other words, the thematic elements implemented may only be present when the gaming machine is idle.

According to embodiments of the present invention, games or groupings of games may be themed to appeal to most any demographic and according to any conceivable characteristic, such as (without limitation) nationality, ethnic, racial or geographic origin, hobby, political association, sexual orientation, preferred sport, musical idol or genre, age and faith, time of day, seasonal considerations and holidays to name but a few of the possible characteristics.

Within the context of implementing predetermined themes on selected gaming machines, embodiments of the present invention may extend the use of code signing and Software Restriction Policy to ensure that only authorized non-executable components (such as the aforementioned graphics, images, video, music and sound effects—collectively, media files—used to build the desired theme) are used by the authorized executable components of the games available for game play on the gaming machines. For this, the non-executable components may reside locally in each of the gaming machines and/or may be placed in code signed MSI installation packages for secured download thereto. As noted above in detail, each individual MSI package is an executable component whose execution can be controlled by Software Restriction Policy (SRP). A distinctive certificate may be created for each package version (a part number is created for a pre-selected aggregate of non-executable components) and the two entities may be bound together by the code signing operation “signcode.exe”, as detailed above. Within the network of gaming machines 2200, trust for non-executable components (such as the media files that together define a theme) may be established by executing the associated authorized code signed packages using SRP upon computer startup or alternatively on demand, resulting in the re-installation of the original non-corrupted non-executable components. The non-executable components may include the initialization or configuration files, the video files, sound files, multimedia files used to construct the desired theme, in addition to other files, such as files containing list of hashes, CRCs, and/or signatures, for example. Such MSI packages (or equivalent) may be downloaded to each of the gaming machines selected to create the theme in the manner disclosed herein and as shown in FIGS. 1-21.

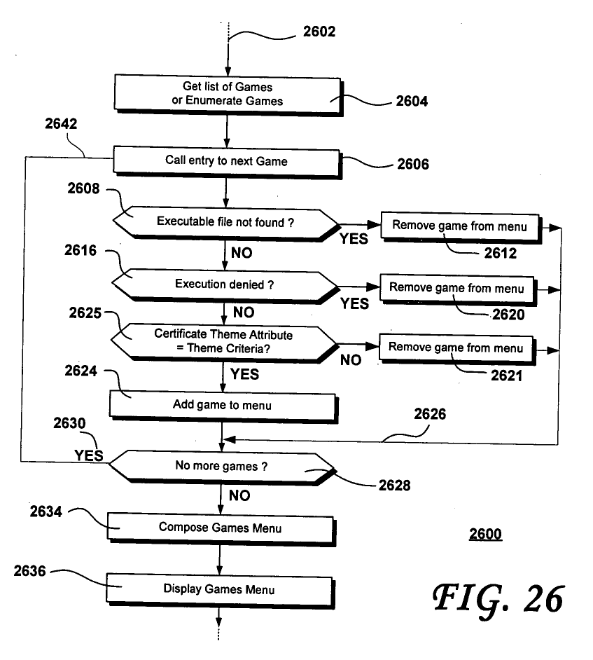

A large number of games may potentially be available to a patron of a gaming machine. Some of these games may be themed according to some characteristic of the patron or according to some other considerations (e.g., special event, birthdays, etc.). All of the potentially available games (potentially hundreds) may be made available to the patron or a more limited number of games may be provided to the patron. It is, therefore, incumbent upon the gaming machine designer to provide some mechanism to facilitate the patron's selection of games. Some of the games may be themed and some may not. Some of the themed games may not be appropriate to a particular patron or group of patrons. Thus, some means of presenting the most appropriate games (e.g., those likely to maximize revenue) to the patron are needed. According to an embodiment of the present invention, the PKI certificate associated with the signed code of a predetermined themed software may include one or a plurality of theme attributes in the subject name string or alternatively in its extended attributes to enable a dynamic generation of themed menus. FIG. 26 illustrates a method 2600 to dynamically generate a menu list of authorized games made available to the patron on each gaming machine. The method starts at 2602, whereupon the gaming machine may obtain a list or enumeration of games that may be potentially available to the patron, as shown at 2604. Each game may then be evaluated in turn to determine whether it should be made available as one of the constituent games in the dynamically generated list of games to be made available to the patron. Step 2606 calls for the evaluation of the first or next game in the list of games. If the executable file(s) associated with the game is not found as shown at 2608 or if execution of the executable file(s) is denied as shown at 2616, the game may be removed from the game menu, as shown at 2612, 2620. However, the executable file(s) is found and the execution thereof allowed (YES branches of 2608, 2616), any remaining games in the list may then be filtered as shown at 2625 on the theme attribute contained in the PKI certificate, according to an embodiment of the present invention. Indeed, step 2625 calls for a determination of whether the theme attribute contained in the PKI certificate matches a theme criteria. The theme criteria may be set centrally, as the result of a player selecting a theme, as a result of criteria extracted from a player tracking system, as a result of criteria derived from video recognition or voice recognition of the patron image or voice, or as a result of the theme selection entered by the floor manager for a bank or a section of gaming machines. If the theme attribute in the certificate associated with a particular game in the obtained list does not match the theme criteria (however obtained), then the game may be removed from the dynamically generated menu, as shown at 2621. If the executable file(s) associated with the game is found, the execution thereof allowed and if the attribute in the certificate matches the theme criteria for that game, then that game may be added to the game menu being dynamically generated, as shown at 2624. If an additional game is present in the list that has not been evaluated as outlined above, the method may revert to step 2642, via the YES branch of step 2628. Otherwise, it may be assumed that all games in the list obtained at 2604 have been evaluated and the menu of games (some of which may be themed, as described above) to be made available to the patron may be composed, as shown at 2634. The thus dynamically generated menu of available games may then be provided (e.g., displayed) to the patron for his or her selection as shown at 2636. It is understood that the menu of available games may be dynamically generated using methods that vary from that illustrative embodiment shown in FIG. 26.

It is to be noted that selection of a theme or of a combination of themes does not impact regulatory issues as it is merely composed of a subset of authorized games to execute at any predetermined gaming machine. As it is anticipated that hundreds of games may potentially be available for a patron to select and play, dynamic menu generation is a means of creating a hierarchy as a default configuration or via a menu list in order to offer a subset of games that are targeted to be appealing to the patron and, therefore, more likely to increase the operator's revenues. In an embodiment, a player may be given the option to select any game of the full library via a succession of menu list pages, but the menu hierarchy may advantageously be dynamically optimized to criteria derived from the identification of the patron or party of patrons. In the case of a menu list, the available games may be organized by page or by folding menus, for example. Preferably, a hierarchy of available games may be provided to the patron, with themed games chosen for their appeal to the patron appearing on or near the top of the hierarchy of available games. Such themed games may be chosen according to the determined characteristic of the patron or group of patrons. In this manner, games that correspond or are otherwise believed to correspond to the patron's characteristics may be located at or near the top of the hierarchy of games presented to the patron. However, the patron may be given the ability to choose any game in the hierarchy or any game that is potentially available to the player at his or her gaming machine. However, going deeper in the provided hierarchy of games or paging through long lists of games will take the patron more time, while tying up a gaming machine that could be made available to other patrons and without generated revenue. An extended list or menu of games may be made available to the patron should the mechanism that determines the patron's characteristics does not match up the patron with his or her most likely game choices—that is, if the games presented to the patron do not meet his or her preferences.

The mechanism or mechanisms that determine the patron's characteristics may take many forms. For example, the patron's characteristics may be determined by enabling the patron to self-select his or her characteristics through a user interface to render the predetermined theme locally on the gaming machine on which the patron is playing. Alternatively, the patron's characteristics may be determined automatically, either by one or more gaming machines or by some device or devices that are external to the gaming machines. For example, the patron's characteristics may be obtained from a player tracking instrument, such as a player loyalty card as shown at 2222 in FIG. 22 or a sign-on ID instrument used by the patron in the gaming machine. From these characteristics, an appropriately themed game or dynamically generated menu of games (none, some or all of which may be themed) may be presented to the patron on his or her gaming machine. Alternatively, the patron's characteristics may be automatically obtained from one or more video cameras (as shown at 2504 in FIG. 25) coupled to the gaming machine or external thereto. After the patron's image is captured by the video camera(s) 2504, video processors may analyze the image to derive therefrom the patron's characteristics to aid in the selection of games and/or themes. Instead of or in combination with the video camera(s), a sound monitoring device or devices may be used together with sound processing means to derive and select the patron's characteristics. These characteristics may be obtained or determined (or the process to determine or obtain them may be initiated) as the patron approaches one of more of the gaming machines or enters the premises housing the gaming machines, for example. In a preferred embodiment of the invention, the patron characteristic selecting step may be dynamically controlled by face/voice recognition software using cameras 2504 and microphones (such as shown at 2506 in FIG. 25) fitted on each gaming machine or set up to monitor a group of gaming machines to determine selected characteristics of the patrons, such as age bracket, clothing style, hair color, language spoken, and ethnic origin (to name but a few possibilities) of an individual patron or a group of patrons.

Alternatively still, the characteristics of the patron or patrons may be manually selected by a casino employee through a user interface, so as to render a predetermined theme or themes on one or selected ones gaming machines. For example, the selection of the characteristics may be carried out centrally by authorized casino personnel or alternatively by a floor manager by entering theme attributes on an entry device. Advantageously, the entry device may be any gaming machine in a bank or section of gaming machines which, upon selection of a predetermined theme by the floor manager using a special logging procedure, would immediately result in selected ones or all of the gaming machines to be configured with the selected theme. Such manual selection may be made on one of the gaming machines upon entering a secret code or may be made from a device that is external to the gaming machines. For example, the characteristics of the patron(s) and/or specific themes may be selected from a portable wireless device 2218 shown in FIG. 22 (such as a PDA-like device, for example) that runs a version of the Windows® operating system (for example) and that is wirelessly coupled to the communication network that interconnects the gaming machines.

The patron's characteristics may be obtained, according to another embodiment of the present invention data mining software may be used to query selected database or databases, such as shown at 2220 in FIG. 22. The information mined from such databases may relate to past present or future patrons of the gaming machines. For example, the data mining software may query databases of travel agencies to obtain information relating to patrons that have recently arrived or are to arrive in the near future. Likewise, the data mining software may query a database of hotel casino guests. Such a hotel casino guest database may contain information that is relevant to expected guest, current guests and/or past guest of the hotel casino in which the gaming machines are disposed.

According to still further embodiments, the patron's characteristics may be obtained upon scanning the patron to detect and extract information from a contact-less patron tracking card, as the patrons move about within a predetermined area such as a casino, a hotel room, restaurants or other common areas. Such contact-less patron tracking cards may include, for example, an embedded Radio Frequency Identification Device (RFID). The patron characteristics may then be determined through polling the RFID of the contact-less patron tracking card and processing information received from the RFID. Such information may identify the patron and/or contain other non-identifying characteristics and/or point to a specific record within one of the above-identified database. IF the RFID device (or equivalent) or the contact-less patron tracking card is configured with an internal power source, the polling step may not be required, as the patron tracking card may broadcast patron information asynchronously as the patron approaches the gaming machine(s). Preferably, the patron characteristic determining step, the game selection step and a step of enabling game play are executed in a close-loop fashion, so as to enable the game selection, theming and game activation to occur in real-time, so as to optimize gaming activity and revenues.

What is claimed is:

1. A method of operating an estate of a plurality of gaming machines connected to a communication network, comprising the steps of:
providing a plurality of software games, each of the plurality of software games being configured to implement a predetermined theme on the gaming machines;
determining at least one characteristic of at least one player;
selecting one of the plurality of software games in accordance with the at least one determined characteristic, and
enabling game play on at least one of the plurality of gaming machines, the game play being configured according to the predetermined theme of the selected one of the plurality of software games.

2. The method of claim 1, wherein the selecting step is carried out with the plurality of software games including at least one of selected images, videos, sound files and TV channels to be rendered on at least one video display of each gaming machine.

3. The method of claim 1, wherein the selecting step is carried out with the plurality of software games including thematic elements targeted at a predetermined population of players of the plurality of gaming machines.

4. The method of claim 1, wherein the predetermined theme is selected according to characteristics including at least one of nationality, ethnic origin, racial identity, geographic origin, favorite hobby, political association, sexual orientation, preferred sport, musical idol or genre, age and faith of players of the plurality of gaming machines.

5. The method of claim 1, wherein the determining step includes enabling the at least one player to self-select the at least one characteristic through a user interface to render the predetermined theme locally on a gaming machine on which the at least one player is playing.

6. The method of claim 1, wherein the determining step includes obtaining the at least one characteristic from a player tracking instrument in order to render the predetermined theme locally on a gaming machine on which the at least one player is playing.

7. The method of claim 6, wherein the player tracking instrument is selected from a group including a player loyalty card and a sign-on ID.

8. The method of claim 1, wherein the determining step includes enabling a casino employee to select the at least one characteristic on a selected one of the plurality of gaming machines in order to render the predetermined theme on a selected one, some or all of the plurality of gaming machines.

9. The method of claim 1, wherein the determining step includes enabling a casino employee to select the at least one characteristic on a device coupled to the communication network in order to render the predetermined theme on a selected one, some or all of the plurality of gaming machines.

10. The method of claim 9, wherein the device is wirelessly coupled to the communication network.

11. The method of claim 10, wherein the device is portable.

12. The method of claim 1, wherein the player of each of the plurality of gaming machines carries out the selecting step through a user interface on a gaming machine on which the player is playing.

13. The method of claim 12, wherein the selecting step is carried out with the user interface including selectable theme icons.

14. The method of claim 1, wherein the selecting step is carried out remotely from the plurality of gaming machines.

15. The method of claim 1, wherein the determining step is carried out using video camera monitoring means and video processing means for deriving the at least one characteristic.

16. The method of claim 15, wherein the video processing means is included in a central server that is coupled to at least one of the plurality of gaming machines through the communication network.

17. The method of claim 15, wherein the determining step is carried out with the video camera monitoring means being disposed at a gaming machine and the video processing means being disposed at a central server, and wherein the method further includes a step of the video camera monitoring means sending unprocessed video data to the central server over the communication network.

18. The method of claim 1, wherein the determining step is carried out using sound monitoring means and sound processing means for deriving the at least one characteristic.

19. The method of claim 18, wherein the sound processing is carried out by the sound processing means at a central server that is coupled to at least one of the plurality of gaming machines through the communication network.

20. The method of claim 18, wherein sound monitoring means is located on at least one of the gaming machines, wherein the sound processing is carried out with the sound processing means being disposed at a central server that is coupled to at least one of the plurality of gaming machines through the communication network, and wherein the method further includes a step of the sound monitoring means sending unprocessed sound data to the central server over the communication network.

21. The method of claim 1, wherein the determining step is carried out using data mining means to obtain the at least one characteristic from a selected database.

22. The method of claim 21, wherein the selected database includes at least one of:
a database of a travel agency containing traveler-related information, and
a database of hotel casino guest information, wherein the plurality of gaming machines are disposed within a hotel casino.

23. The method of claim 22, wherein the travel agency and hotel casino guest information databases include information related to at least one of currently expected, residing and departed traveler and hotel casino guests, respectively.

24. The method of claim 1, wherein the determining step is carried out using detection of a contact-less patron tracking card, as the patrons move about a predetermined area.

25. The method of claim 24, wherein the predetermined area includes at least one of a casino and hotel.

26. The method of claim 24, wherein the contact-less patron tracking card includes a Radio Frequency Identification Device (RFID) and wherein the determining step includes steps of polling the RFID of the contact-less player tracking card and processing information received from the RFID.

27. The method of claim 1, wherein the determining, selecting and enabling steps are executed in a close-loop fashion such as to optimize patron game activity in real-time.

28. The method of claim 1, further carrying out a step of dynamically generating a hierarchical menu of games available on a gaming machine on which the player is playing, the hierarchical menu ranking games being constructed so as to appeal to the player according to the determined characteristics.

29. The method of claim 28, wherein the hierarchical menu includes themed games and non-themed games to be played on the gaming machine on which the player is playing.

30. The method of claim 28 further comprising the step of hierarchically presenting the generated menu in a selected set of recursive pages of submenus and of a collapsible menu list.

31. The method of claim 28 wherein the menus and submenus include at least one of text lists and icons.

32. The method of claim 1, wherein the providing step is carried out with the plurality of software games having been certified to comply with applicable game regulatory requirements.

33. The method of claim 1, wherein the providing step includes downloading the software games over the communication network from a central server under centrally configured installation restriction policies.

34. The method of claim 1, wherein the enabling step includes enabling the executable files of the software games to execute under centrally configured execution restriction policies.

35. The method of claim 1, wherein the determining step is initiated as the at least one player is approaching at least one of the plurality of gaming machines.

36. The method of claim 1, wherein the determining step is initiated as the at least one player is entering a gaming premise housing the estate of gaming machines.

37. The method of claim 1, wherein the enabling step is initiated as the at least one player is approaching at least one of the plurality of gaming machines.

38. The method of claim 1, wherein the enabling step is initiated as the at least one player is entering a gaming premise housing the estate of gaming machines.

39. A method for dynamically generating on a gaming machine a menu of at least one software game to appeal to a player according to his or her characteristics, the gaming machine being coupled to a communication network and operating as one of a plurality of gaming machines of an estate of gaming machines that are controlled by a central server, the central server enabling at least one executable software component of each software game to execute under centrally configured execution certificate restriction policies, and wherein when any software game is selected and played by the player, the method comprises the steps of:
binding at least one executable software component of each software game with a pre-selected authorized code-signing certificate, the code signing certificate comprising at least one predetermined theme attribute;
enforcing execution restriction policies for the pre-selected authorized code-signing certificate;
installing at least one of the software games on the gaming machine;
selecting a theme according to the characteristics of the player;
inventorying each of the at least one software games and verifying attributes of the associated code signing certificates;
determining whether the theme attribute of the code-signing certificate matches the selected theme, and
generating a menu of software games whose theme attribute match the selected theme.

40. The method of claim 39 wherein the generated menu is presented hierarchically.

41. The method of claim 39 further comprising the step of hierarchically presenting the generated menu in a selected set of recursive pages of submenus and of a collapsible menu list.

42. The method of claim 41 wherein the menus and submenus include at least one of text lists and icons.

43. The method of claim 39 wherein the at least one predetermined theme attribute of the code signing certificate includes at least one of a text code concatenated with the certificate subject name and a field in the certificate extension.

44. The method of claim 39, wherein the pre-selected authorized code-signing certificate is distinct for each executable component of each authorized software game.

45. The method of claim 39, wherein the selecting step, the inventorying step, determining step and the generating step are carried out in a close-loop fashion in real-time.

46. The method of claim 39, wherein the at least one software game includes at least one of selected images, videos, sound files and TV channels to be rendered on at least one video display of each gaming machine.

47. The method of claim 39, wherein the at least one software game includes thematic elements targeted at a predetermined population of players of the plurality of gaming machines.

48. The method of claim 39, wherein the at least one predetermined theme attribute is selected according to characteristics including at least one of nationality, ethnic origin, racial identity, geographic origin, favorite hobby, political association, sexual orientation, preferred sport, musical idol or genre, age and faith of players of the plurality of gaming machines.

49. The method of claim 39, wherein the selecting step includes enabling the at least one player to self-select a theme through a user interface to render the predetermined theme locally on a gaming machine on which the at least one player is playing.

50. The method of claim 39, wherein the selecting step includes obtaining the at least one characteristic from a player tracking instrument in order to render the predetermined theme locally on a gaming machine on which the at least one player is playing.

51. The method of claim 50, wherein the player tracking instrument is selected from a group including a player loyalty card and a sign-on ID.

52. The method of claim 30, wherein the selecting step includes enabling a casino employee to select the at least one characteristic on a selected one of the plurality of gaming machines in order to render the predetermined theme on a selected one, some or all of the plurality of gaming machines.

53. The method of claim 39, wherein the selecting step includes enabling a casino employee to select the at least one characteristic on a device coupled to the communication network in order to render the predetermined theme on a selected one, some or all of the plurality of gaming machines.

54. The method of claim 53, wherein the device is wirelessly coupled to the communication network.

55. The method of claim 54, wherein the device is portable.

56. The method of claim 39, wherein the player of each of the plurality of gaming machines carries out the selecting step through a user interface.

57. The method of claim 56, wherein the user interface in the selecting step includes selectable theme icons.

58. The method of claim 39, wherein the selecting step is carried out remotely from the plurality of gaming machines.

59. The method of claim 39, wherein the selecting step is carried out using video camera monitoring means and video processing means for deriving the at least one characteristic.

60. The method of claim 59, wherein the selecting step is carried out with the video processing means being disposed at the central server.

61. The method of claim 59, wherein the selecting step is carried out with the video camera monitoring means being disposed on a gaming machine and the video processing means being disposed in the central server, and wherein the method further includes a step of the video camera monitoring means sending unprocessed video data to the central server over the communication network.

62. The method of claim 39, wherein the selecting step is carried out using sound monitoring means and sound processing means for deriving the at least one characteristic.

63. The method of claim 62, wherein the selecting step is carried out with the sound processing means being disposed at the central server.

64. The method of claim 62, wherein the sound monitoring means is located on at least one of the gaming machines, wherein the sound processing is carried out with the sound processing means being disposed at the central server, and wherein the method further includes a step of the sound monitoring means sending unprocessed sound data to the central server.

65. The method of claim 39, wherein the selecting step is carried out using data mining means to obtain the at least one characteristic from a selected database.

66. The method of claim 65, wherein the selected database includes at least one of:
a database of a travel agency containing traveler-related information, and
a database of hotel casino guest information, wherein the plurality of gaming machines are disposed within a hotel casino.

67. The method of claim 66, wherein the travel agency and hotel casino guest information databases include information related to at least one of currently expected, residing and departed traveler and hotel casino guests, respectively.

68. The method of claim 39, wherein the determining step is carried out using detection of a contact-less patron tracking card, as the patrons move about a predetermined area.

69. The method of claim 68, wherein the predetermined area includes at least one of a casino and hotel.

70. The method of claim 68, wherein the contact-less patron tracking card includes a Radio Frequency Identification Device (RFID) and wherein the determining step includes steps of polling the RFID of the contact-less player tracking card and processing information received from the RFID.

71. The method of claim 39, wherein the at least one software game has been certified to comply with applicable game regulatory requirements.

72. The method of claim 39, wherein the installing step includes downloading the at least one software game over the communication network from the central server under centrally configured installation restriction policies.

73. The method of claim 39, wherein the selecting step is initiated as the at least one player is approaching at least one of the plurality of gaming machines.

74. The method of claim 39, wherein the selecting step is initiated as the at least one player is entering premises housing the estate of gaming machines.

75. The method of claim 39, wherein the selecting step is initiated as the at least one player is approaching at least one of the plurality of gaming machines.

76. The method of claim 39, wherein the installing step is performed with the at least one software game packaged within a code signed MSI installation package that is downloaded to the gaming machine through the communication network and wherein the at least one software game is allowed to be installed via enforced certificate policies configured centrally applied on the code signed MSI installation package.

77. The method of claim 76 wherein each MSI installation package is code signed with a distinctive PKI certificate.
